(19) United States
(12) Patent Application Publication
(10) Pub. No.: US 2026/0329824 A1
(43) Pub. Date: Oct. 22, 2026

(54) SYSTEM

(71) Applicant: SoftBank Group Corp., Tokyo (JP)

(72) Inventor: Tomono NAGANO, Tokyo (JP)

(73) Assignee: SoftBank Group Corp., Tokyo (JP)

(21) Appl. No.: 19/649,166

(22) Filed: Apr. 16, 2026

(30) Foreign Application Priority Data
Apr. 22, 2025 (JP) 2025-070919

(51) Int. Cl. G06F 16/215; G06N 3/0475

(52) U.S. Cl. CPC G06F 16/215; G06N 3/0475

(57) ABSTRACT

The present invention relates to a system that automatically collects customer data from a plurality of data sources such as an SNS, a website browsing history, a purchase history, and an application usage status, performs an integration process including identification and cleansing, and then multilaterally analyzes interests, purchasing tendencies, behavior patterns, and the like for each customer using a generative AI to construct a customer profile. Furthermore, the generative AI automatically generates and selects an optimal advertisement content, distribution timing, and distribution channel for each customer, and analyzes performance data after advertisement distribution to continuously optimize them, thereby realizing real-time and highly accurate personalized advertisement distribution.

### CROSS-REFERENCE TO RELATED APPLICATION

The present application claims priority to and incorporates by reference the entire contents of Japanese Patent Application No. 2025-070919 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention includes a problem that, in companies utilizing digital marketing, customer data exists distributed across a plurality of data sources such as an SNS, a website browsing history, a purchase history, and an application usage status, and each data is managed individually, making it difficult to construct an integrated profile for each customer, and as a result, a highly personalized advertisement in line with customer interests and behaviors cannot be distributed at an appropriate timing and channel, and an advertisement effect and a conversion rate are not sufficiently improved, further, a problem that, in conventional systems, each process such as data identification, cleansing, profiling, advertisement generation, and distribution optimization was performed fragmentarily and manually, so that real-time performance and automatic optimization could not be realized, and highly accurate personalized advertisement distribution utilizing a huge amount of data was difficult, in addition, a problem that, in conventional advertisement distribution, an advertisement content is uniform, and automatic generation of an advertisement creative and optimization of a distribution channel and timing in immediate response to preferences and behavior changes for each customer cannot be performed, so that customer interest cannot be attracted, and advertisement cost-effectiveness decreases, and furthermore, a problem that performance data after advertisement distribution cannot be sufficiently utilized, and continuous improvement of the advertisement effect is difficult, and in order to solve these problems, an object of the present invention is to automatically realize, in an integrated manner, integration and analysis of customer data from a plurality of data sources in real time, construction of a customer profile using a generative AI, automatic generation of an advertisement content, optimization of a distribution channel and timing, and continuous advertisement optimization by feedback based on performance data.

### SUMMARY OF THE INVENTION

A means for solving the above problems is to comprise: a data collection unit configured to automatically collect customer data from a plurality of data sources; a data integration unit configured to integrate the customer data collected by the data collection unit, and execute a data cleansing process including data identification, normalization, deduplication, noise removal, and attribute complementation to generate an integrated customer data set; an advertisement generation and distribution unit configured to analyze the integrated customer data set using a generative AI, extract interests, purchasing tendencies, behavior patterns, usage channels, active time zones, and other attribute information for each customer to construct a customer profile, further determine an advertisement content and a distribution timing using the generative AI based on the customer profile, and automatically generate and distribute an advertisement personalized for each customer through a plurality of distribution channels; and a performance monitoring and feedback unit configured to monitor performance indicators such as the number of impressions, the number of clicks, and the number of conversions after the advertisement distribution by the advertisement generation and distribution unit in real time, analyze a result thereof using the generative AI, and automatically execute optimization of the advertisement content, the distribution timing, and the distribution channel, wherein the respective units operate in cooperation using the generative AI, thereby realizing advertisement distribution optimized for each customer in real time and automatically, and aiming to maximize an advertisement effect and a conversion rate.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

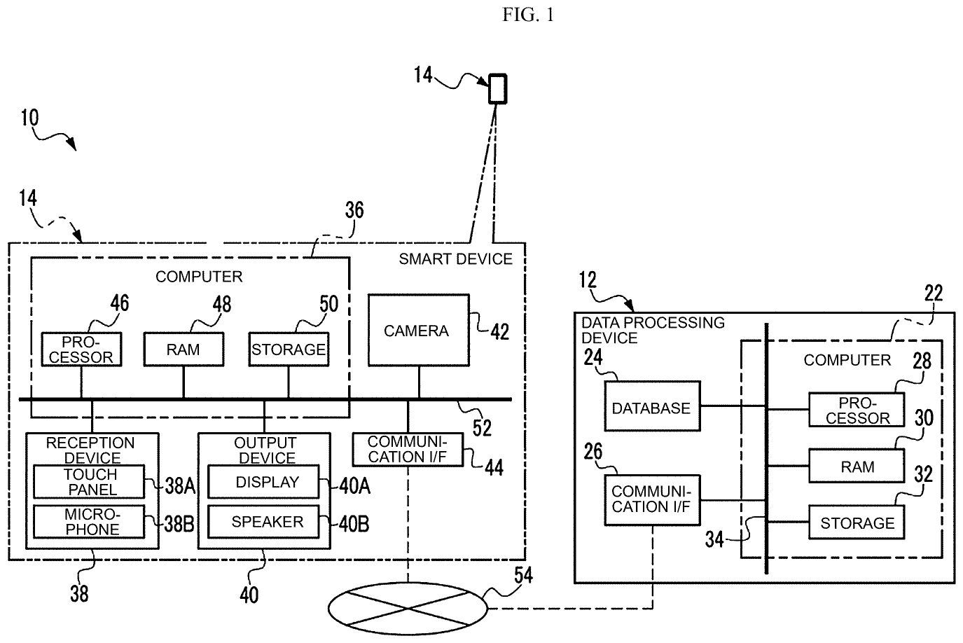

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

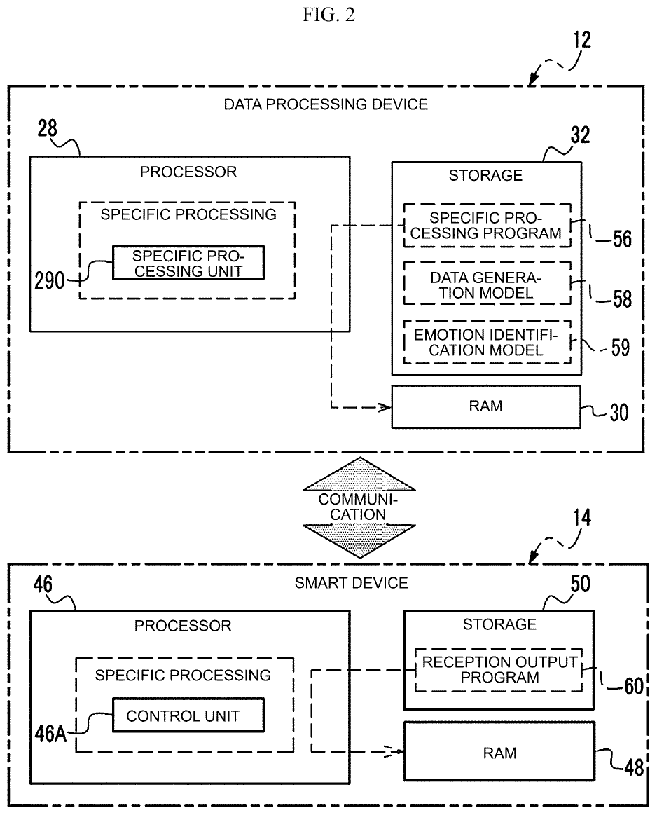

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

Embodiments for carrying out the present invention will be described more specifically and in detail.

The system of the present invention is composed of a server and a terminal (a smartphone, a tablet, a personal computer, etc.), and is configured such that a data collection unit, a data integration unit, a data analysis unit, an advertisement generation and distribution unit, and a performance monitoring and feedback unit are provided on the server side, and a data collection auxiliary function, an advertisement display function, and a user interface function are provided on the terminal side.

First, regarding the data collection unit, on the server side, information such as what kind of posts a customer makes, which posts the customer “likes” or comments on, which accounts the customer follows, and what topics and hashtags the customer frequently uses is acquired using an API of an SNS. For example, when the customer makes many posts related to topics such as “travel”, “gourmet”, and “home appliances”, the interests thereof are extracted. Further, on the terminal side, a detailed website browsing history such as which websites the customer has visited, which pages the customer has browsed and for how long, which links the customer has clicked, and which search words the customer has input is collected using an extension function of a web browser, a cookie, and a tracking tag, and is transmitted to the server. For example, when the customer frequently inputs search words such as “cheap smartphone”, “overseas travel insurance”, and “latest home appliances”, the search tendency thereof is grasped. Furthermore, regarding the purchase history, detailed information such as a product name, a category, a purchase date and time, a purchase amount, a purchase frequency, and a purchase channel (online/physical store) purchased by the customer in the past is acquired by database linkage between an EC site or a POS system and the server side. For example, when the customer purchases travel goods every summer, seasonal purchasing tendencies are grasped. Regarding the application usage status, an application on the terminal side generates a usage log, and detailed behavior data such as which application is launched and how often, which function (chat, video viewing, shopping, news browsing, etc.) is used in the application and in which time zone, and which button or link is tapped is transmitted to the server. For example, when the customer frequently uses the video viewing function in the midnight time zone, a night-type lifestyle pattern is estimated. Specifically, the present system comprises the data collection unit. The data collection unit has a plurality of data collection nodes based on a distributed processing architecture. The data collection node executes asynchronous communication with an application programming interface provided by an external social networking service. The data collection node acquires time-series data including a customer's posted text, a time stamp, and metadata. The data collection node inputs the acquired time-series data to a natural language processing model. The natural language processing model is a large language model based on a transformer architecture. Input data to the natural language processing model is a text tensor converted into a word embedding vector. The number of dimensions of the text tensor is, for example, 512 dimensions. As a specific example of the input data, text data “the weekend hot spring trip was the best” posted by the customer can be cited. As another specific example, text data “purchased the latest noise-canceling earphones” can be cited. The natural language processing model extracts a feature amount from the input text tensor. The natural language processing model outputs an interest score of the customer based on the extracted feature amount. A format of the output data is a numerical vector indicating a probability distribution for each category. The output value indicates, for example, a score of 0.85 for a travel category and 0.12 for a home appliance category. As another specific example, a score of 0.91 is output for a gourmet category. The present system transmits this output result to the subsequent data integration unit. The present system executes the extension function of the web browser on the terminal side. The extension function captures an operation log of the customer using an event listener of a document object model. The operation log is structured data including coordinates of a mouse click, a scroll amount, and a stay time. The present system periodically transmits this operation log to the server. The present system establishes a secure communication channel with a database of an electronic commerce site. The present system extracts purchase history data. The purchase history data is multidimensional array data including a product identifier, a purchase unit price, and a purchase date and time. The present system receives a usage log from the application on the terminal side. The usage log is a time-series array including a history of screen transitions and a button press event. The present system grasps the behavior patterns of the customer with high accuracy by collecting these diverse data. A technical effect of this processing is an improvement in comprehensiveness of data collection and securing of real-time performance. The present system efficiently collects a large amount of data while suppressing consumption of a network bandwidth by using asynchronous communication and distributed processing. As a specific application field, the present system is applicable to a customer behavior analysis system in a large-scale electronic commerce platform.

The data integration unit operates on the server, and centrally manages and integrates the diverse data transmitted from the data collection unit. For example, data having different ID systems, such as an account ID of an SNS, a member ID of an EC site, a user ID of an application, and a cookie ID of a web browser, are subjected to identification processing using common attributes such as an e-mail address, a telephone number, a terminal identifier, location information, an IP address, and behavior patterns, and are integrated as data of the same person. For example, when a customer registers for a plurality of services using the same e-mail address, they are combined into one customer profile. Regarding differences in data formats, date notations (YYYY/MM/DD, MM-DD-YYYY, etc.), currency units (yen, dollar, etc.), and notational fluctuations of category names (smartphone, sumaho, etc.) are automatically unified. Regarding duplicate data, when the same purchase history or browsing history is acquired from a plurality of data sources, time stamps and contents are compared to execute deduplication. As the noise removal processing, for example, abnormally expensive purchase data, a non-existent product ID, and an abnormal access frequency (access by a bot, etc.) are detected, and excluded or corrected. When a missing value exists, missing value complementation is executed by estimation from other behavior histories or data of similar customers using the generative AI, for example, when a purchase date and time of a purchase history is missing. Furthermore, for example, when a posted content of an SNS is unclear, semantic analysis by natural language processing is performed to execute attribute estimation of related attributes. Specifically, the present system comprises the data integration unit. The data integration unit executes a data cleansing process in a memory space on the server. The data integration unit has an identification engine for integrating data having different identifier systems. The identification engine determines the identity of a customer using a graph neural network. Input data to the graph neural network is graph structure data in which each identifier is a node and a common attribute is an edge. As a specific example of the input data, a pair of a social media account and an electronic commerce account sharing an e-mail address can be cited. As another specific example, a plurality of application usage logs having the same terminal identifier can be cited. The graph neural network calculates a similarity between nodes. The graph neural network outputs a score indicating a probability of being the same person. A format of the output data is a floating-point number taking a continuous value from 0 to 1. The output value indicates a high probability of, for example, 0.95. As another specific example, it indicates a low probability of 0.21. The data integration unit integrates a plurality of identifiers into a single customer profile when this output score exceeds a preset threshold value. The data integration unit executes normalization processing of a data format. The data integration unit converts a date character string into a standardized time stamp format using a regular expression. The data integration unit absorbs notational fluctuations of category names using a natural language processing model. The data integration unit executes a hash function for eliminating duplicate data. The data integration unit calculates a hash value of each data record, and deletes matching records. The data integration unit removes noise data using an anomaly detection model. The anomaly detection model is a neural network based on an autoencoder architecture. The anomaly detection model calculates a reconstruction error of input data. The data integration unit excludes data whose reconstruction error exceeds a threshold value as an abnormal value. The data integration unit executes a generative artificial intelligence model for complementing a missing value. The generative artificial intelligence model has an architecture based on a generative adversarial network. Input data to the generative artificial intelligence model is a behavior history vector of a customer including a missing part. The generative artificial intelligence model outputs a complete behavior history vector in which the missing part is estimated. The data integration unit stores this output result in an integrated database. A technical effect of this processing is a dramatic improvement in data quality and an improvement in accuracy in subsequent analysis processing. The present system automates complex data integration and missing value complementation, which have been difficult with conventional methods, by combining the graph neural network and the generative artificial intelligence. As a specific application field, the present system is applicable to an integrated customer management system in a conglomerate company developing a plurality of services.

The data analysis unit operates on the server, and analyzes the integrated customer data set from multiple angles using the generative AI. For example, posted contents and a comment history of an SNS are analyzed by natural language processing to extract interests (travel, gourmet, sports, home appliances, fashion, etc.) of a customer. From a website browsing history, categories of browsed pages and search words are analyzed to specify products and services in which the customer is currently interested. From a purchase history, a category of a purchased product, a price range, a purchase frequency, a purchase cycle, a brand preference, price sensitivity, and the like are extracted. For example, when a subscription service of a fixed amount is used every month, it is determined that a regular purchasing tendency is strong. From an application usage status, frequently used functions, usage time zones, and actions in the application (adding to a cart, adding to a wish list, posting a review, etc.) are analyzed to estimate behavior patterns and a lifestyle of the customer. For example, when a shopping function is used in the daytime on weekdays and a video viewing function is used at night, it is determined that information gathering is strong in the daytime and entertainment orientation is strong at night. These profiling processes are automatically executed by the generative AI learning a vast amount of past data and combining methods such as pattern recognition, clustering, attribute estimation, time-series analysis, and anomaly detection. For example, a purchase cycle of the customer can be predicted by time-series analysis to estimate the next purchase timing. Specifically, the present system comprises the data analysis unit. The data analysis unit has a plurality of machine learning models for processing the integrated customer data set. The data analysis unit analyzes text data using a natural language processing model. The natural language processing model adopts a transformer architecture equipped with a self-attention mechanism. Input data to the natural language processing model is an integer array obtained by tokenizing the posted contents and search words of the customer. The number of dimensions of the input data is equal to a maximum token length. As a specific example of the input data, a token array of text “comparing the latest smartphones” can be cited. As another specific example, a token array of text “recommendations for weekend campsites” can be cited. The natural language processing model generates a context vector from the input token array. The natural language processing model classifies interest categories of the customer. Output data from the natural language processing model is an output vector of a softmax function indicating a belonging probability for each category. The output value indicates a probability of, for example, 0.88 for a gadget category. As another specific example, it indicates a probability of 0.92 for an outdoor category. The data analysis unit records this output result in a customer profile database. The data analysis unit analyzes the purchase history and the application usage status using a time-series analysis model. The time-series analysis model adopts a long short-term memory network architecture. Input data to the time-series analysis model is a time-series tensor in which past purchase amounts and usage frequencies are arranged in chronological order. As a specific example of the input data, an array of monthly purchase amounts for the past 12 months can be cited. As another specific example, an array of the number of application launches by time zone for the past 7 days can be cited. The time-series analysis model learns a temporal dependency relationship from the time-series tensor. The time-series analysis model predicts the next purchase timing and usage probability. Output data from the time-series analysis model is numerical data indicating a purchase probability in a specific future period. The output value indicates, for example, that a purchase probability for the next week is 0.75. The data analysis unit segments customers using a clustering algorithm. The data analysis unit executes density-based spatial clustering on a customer feature vector mapped to a high-dimensional space. A technical effect of this processing is highly accurate prediction of potential needs and behavior patterns of the customer. The present system extracts a complex correlation that cannot be discovered by human intuition or a simple rule base by using a deep learning model. As a specific application field, the present system is applicable to a personalized product recommendation system and a dynamic pricing system.

The advertisement generation and distribution unit operates on the server, learns a customer profile, an advertisement distribution history, and performance indicators using the generative AI, and automatically generates an optimal advertisement creative (an image, text, a video, etc.) for each customer. For example, for a customer who likes traveling, a landscape image of a popular travel destination and a banner advertisement of a travel plan are automatically generated using an image generation technology by the generative AI, and a catchphrase such as “Limited time only! Summer vacation travel special” is automatically created using a text generation technology. For a customer interested in smartphones, a spec comparison table of the latest models and an introduction video of accessories are automatically generated. For a fashion-oriented customer, a coordinated image combining trend items of this season and a recommended comment by a stylist are automatically generated. As distribution channels for advertisements, there are an SNS, an e-mail, a push notification, a web advertisement, an in-app advertisement, and the like, and the generative AI learns a usage tendency and a past reaction for each customer, and automatically selects an optimal channel and distribution timing. For example, if an active time zone on an SNS is at night, an SNS advertisement is distributed at night, and an e-mail advertisement is transmitted in the morning to a customer with a high e-mail open rate. On the terminal side, the distributed advertisement is displayed, and the customer can perform actions such as browsing, clicking, and purchasing the advertisement through a user interface. For example, when an advertisement banner is clicked, a transition is made to a product detail page or a purchase page, and a purchase procedure can be performed with one click. Specifically, the present system comprises the advertisement generation and distribution unit. The advertisement generation and distribution unit dynamically generates an advertisement creative using a generative artificial intelligence model. The generative artificial intelligence model includes an image generation network based on a latent diffusion model and a text generation network based on a large language model. Input data to the image generation network is a conditioning tensor obtained by combining an interest vector of the customer and prompt text. As a specific example of the input data, a text feature amount “Hawaii beach, dusk, luxury resort” and a customer attribute vector indicating a love for travel can be cited. As another specific example, a text feature amount “latest smartwatch, cyberpunk-style background” can be cited. The image generation network executes a reverse diffusion process of removing noise stepwise from a random noise tensor. Output data from the image generation network is a three-dimensional tensor indicating pixel values of the generated image. The output value is, for example, RGB image data with a resolution of 1024 by 1024. Input data to the text generation network is a context vector including feature information of a product and attribute information of the customer. The text generation network generates words autoregressively. Output data from the text generation network is character string data serving as a catchphrase of the advertisement. As a specific example of the output value, a character string “A tropical resort experience perfect for you” can be cited. As another specific example, a character string “Next-generation performance in your hands” can be cited. The advertisement generation and distribution unit synthesizes the generated image and text to construct a final advertisement banner. The advertisement generation and distribution unit determines an optimal distribution channel and timing using a reinforcement learning model. Input data to the reinforcement learning model is a state vector indicating a current state of the customer. The state vector includes a time, a day of the week, and a past reaction history. The reinforcement learning model calculates an expected reward for each distribution action. Output data from the reinforcement learning model is an action vector indicating an optimal distribution channel and time. The output value indicates, for example, an instruction to distribute via social media at 8:00 PM. The present system transmits a distribution request to an advertisement distribution server in accordance with this instruction. A technical effect of this processing is a dramatic reduction in advertisement production costs and maximization of customer engagement. The present system provides an advertisement completely optimized for each individual customer in real time by combining the generative artificial intelligence and the reinforcement learning. As a specific application field, the present system is applicable to a digital marketing platform and a programmatic advertisement distribution system.

The performance monitoring and feedback unit operates on the server, automatically aggregates performance indicators such as the number of impressions, the number of clicks, a click rate, the number of conversions, a conversion rate, a stay time, a bounce rate, a purchase unit price, a repeat rate, and sales via advertisement after advertisement distribution in real time, and visualizes them on a dashboard. For example, an effect is analyzed for each advertisement, each customer segment, each distribution channel, and each time zone to determine which advertisement was effective for which customer segment, and which channel and timing were most effective. The generative AI analyzes these performance data, and automatically and continuously optimizes a selection logic of an advertisement content, a distribution timing, and a distribution channel. For example, when the click rate is low, the advertisement creative is changed, the distribution time zone is adjusted, or discount campaign information is added. Furthermore, an A/B test and a multivariate test are automatically executed to select an advertisement pattern with the highest effect. For example, a plurality of advertisements using different catchphrases and images for the same product are distributed, and which pattern shows the highest conversion rate is automatically determined. Specifically, the present system comprises the performance monitoring and feedback unit. The performance monitoring and feedback unit aggregates the performance indicators in real time using a stream processing engine. The stream processing engine continuously receives an event log transmitted from the advertisement distribution server and the terminal. The event log includes data such as an impression identifier, a click flag, a conversion flag, and a stay time. The performance monitoring and feedback unit accumulates the received event log in an in-memory database. The performance monitoring and feedback unit inputs the aggregated data to an evaluation model. The evaluation model is a machine learning model based on a gradient boosting decision tree algorithm. Input data to the evaluation model is a multidimensional feature vector including a feature amount of the advertisement, a feature amount of the customer, and the aggregated performance indicators. As a specific example of the input data, a vector including a color histogram of a specific banner image, an age group of the customer, and a click rate for the past hour can be cited. As another specific example, a vector including a distribution time zone, the number of characters of a catchphrase, and a conversion rate can be cited. The evaluation model calculates an effectiveness score of the advertisement based on the input feature vector. Output data from the evaluation model is a continuous value score predicting future performance of each advertisement pattern. The output value indicates a high effectiveness of, for example, 0.89 for a specific advertisement pattern. As another specific example, it indicates a low effectiveness of 0.34. The performance monitoring and feedback unit dynamically updates an advertisement distribution strategy based on this output score. The performance monitoring and feedback unit immediately stops distribution of an advertisement whose score falls below a threshold value. The performance monitoring and feedback unit executes an automatic test using a multi-armed bandit algorithm. The multi-armed bandit algorithm dynamically evaluates a plurality of advertisement patterns while optimizing a trade-off between exploration and exploitation. A technical effect of this processing is complete automation of advertisement operation and continuous improvement of return on investment. The present system self-learns an optimal advertisement strategy without human intervention by combining real-time data processing and a machine learning model. As a specific application field, the present system is applicable to an automatic bidding system and a campaign optimization tool in a large-scale advertising agency.

Further, the generative AI utilizes a combination of various AI technologies such as analysis of posted contents by natural language processing, automatic creation of a banner advertisement by image generation, estimation of an optimal distribution timing by time-series analysis, optimization of an advertisement distribution strategy by reinforcement learning, automatic extraction of a customer segment by clustering, and exclusion of unauthorized access and spam behavior by anomaly detection. For example, even when a customer begins to have a new interest or when purchasing tendencies change, the generative AI can learn data in real time and immediately update an advertisement content and a distribution strategy. For example, it is possible to flexibly respond to seasonal trend changes, launches of new products, and growing interest in social events. Specifically, the present system comprises an orchestration module that integrally controls a plurality of artificial intelligence models. The orchestration module manages a data flow between the respective artificial intelligence models. The present system determines an emotional polarity from posted contents of social media using a natural language processing model. Input data to the natural language processing model is a word embedding vector of posted text. Output data from the natural language processing model is a vector indicating a probability distribution of positive, negative, and neutral. The present system synthesizes a product image tailored to a customer's preference using an image generation model. Input data to the image generation model is a latent vector indicating a basic image of a product and a style preference of the customer. Output data from the image generation model is a style-converted high-resolution image tensor. The present system predicts a life event of the customer using a time-series analysis model. Input data to the time-series analysis model is a time-series array of a purchase history for the past several years. Output data from the time-series analysis model is a score indicating a probability of occurrence of a life event such as moving or marriage. The present system learns a distribution policy that maximizes a long-term customer lifetime value using a reinforcement learning model. The reinforcement learning model models state transitions and rewards based on a Markov decision process. A reward function of the reinforcement learning model is designed to evaluate not only a short-term click rate but also a total of long-term purchase amounts. The present system extracts a dynamically changing customer segment using a clustering model. The clustering model estimates a probability density of a customer feature space using a Gaussian mixture model. The present system blocks an unauthorized click bot in real time using an anomaly detection model. Input data to the anomaly detection model is a behavior feature vector including mouse tracking data and an access frequency of an IP address. Output data from the anomaly detection model is an anomaly score indicating a probability of being unauthorized access. A technical effect of this processing is an improvement in a comprehensive intelligence level of the system due to a synergistic effect of diverse artificial intelligence technologies. The present system executes advanced inference that cannot be realized by a single model by using an output of each model as an input of another model in a chained manner. As a specific application field, the present system is applicable to an advanced autonomous marketing agent system.

Furthermore, from the viewpoint of security and privacy protection, customer data is encrypted and transmitted to the server, and access authority management and anonymization processing are executed. For example, personally identifiable information is hashed, and only anonymized data is used for advertisement distribution and analysis. A function that allows a customer to opt out of data collection and advertisement distribution in accordance with privacy settings is also provided on the terminal side. Specifically, the present system comprises a security and privacy management unit. The security and privacy management unit securely manages an encryption key using a hardware security module. The present system encrypts a communication path using a transport layer security protocol during data transmission from the terminal to the server. The present system encrypts a data payload using an advanced encryption standard algorithm before storing the received customer data in a database. The present system applies an irreversible hash function to personally identifiable information. The hash function converts an input character string into a fixed-length hash value using a secure hash algorithm. The present system prevents a rainbow table attack by adding a random salt value during hashing. The present system provides only an anonymized data set to the data analysis unit and the advertisement generation and distribution unit. The present system reduces a risk of identifying an individual in the data set using a k-anonymity algorithm. The present system automatically executes generalization of attribute information and suppression processing of a record. The present system provides a privacy setting screen through a user interface unit on the terminal side. When receiving an opt-out request from a customer, the present system registers an identifier of the corresponding customer in an opt-out management database. The present system collates whether or not an identifier to be processed exists in the opt-out management database in the data collection unit and the advertisement distribution unit. When the corresponding identifier is detected, the present system immediately stops processes of data collection and advertisement distribution. The present system strictly manages access authority for each module in the server using an access control list. The present system requests authentication and authorization for all internal communications based on a zero-trust architecture. A technical effect of this processing is minimization of an information leakage risk and complete compliance with privacy regulations. The present system secures a high security level while maintaining usefulness of data by incorporating an encryption technology and an anonymization algorithm into a core of the system. As a specific application field, the present system is applicable to a marketing system for industries requiring strict data protection, such as financial institutions and medical institutions.

As described above, the embodiment of the present invention is configured with depth from all viewpoints, such as cooperative operation of a server and a terminal, multilayered and continuous utilization of a generative AI, integrated operation of diverse data sources and distribution channels such as an SNS, a website, an EC site, and an application, real-time data processing and advertisement optimization, and thorough security and privacy protection, and realizes unprecedentedly highly accurate and highly efficient personalized advertisement distribution.

### System Configuration

The system according to the present embodiment comprises a data collection unit, a data integration unit, a data analysis unit, an advertisement generation and distribution unit, a performance monitoring and feedback unit, a user interface unit, and a security and privacy management unit.

The data collection unit has a function of acquiring a customer's posted content, like history, comment history, follow relationship, usage frequency, trend topic participation status, and the like using an API of an SNS, and also has a function of collecting a detailed website browsing history such as which website the customer visited, which page the customer browsed for how long, which link the customer clicked, which search word the customer input, and which banner advertisement the customer browsed using an extension function of a web browser, a cookie, and a tracking tag, and transmitting the detailed website browsing history to a server. Further, it has a function of acquiring a detailed purchase history such as a product name, a category, a purchase date and time, a purchase amount, a purchase frequency, a purchase channel, a return history, and a review posting history purchased by the customer in the past in cooperation with a database of an EC site or a POS system. In addition, an application on a terminal side generates a usage log, and has a function of transmitting detailed behavior data such as which application is activated at what frequency, which function (chat, video viewing, shopping, news browsing, coupon usage, point acquisition, etc.) is used in which time zone in the application, which button or link is tapped, and a purchase or billing history in the application to the server. For example, diverse data for grasping a lifestyle pattern and a usage tendency, such as a case where the customer frequently uses the video viewing function late at night or a case where the customer uses the shopping function in the daytime on weekdays, is collected. Specifically, the present system comprises the data collection unit. The data collection unit has a multi-thread processing mechanism that asynchronously acquires data from a plurality of data sources. The data collection unit transmits a secure request using OAuth authentication to an application programming interface of a social networking service. The data collection unit parses response data returned in a JSON format, and extracts a necessary field. The data collection unit inputs the extracted text data to a natural language processing model. Input data to the natural language processing model is an array of token IDs obtained by dividing a text character string in units of subwords. As a specific example of the input data, a token array of a text “coffee at a new cafe is delicious” posted by the customer can be cited. As another specific example, a token array of a text “size of running shoes does not fit” can be cited. Output data from the natural language processing model is a one-hot vector indicating a topic classification result of the text. The output value is, for example, a vector indicating that it corresponds to a food and drink topic. The present system executes a JavaScript-based tracking code in the web browser on the terminal side. The tracking code monitors a change in a document object model, and measures a screen scroll position of the customer and a hover time of an element. The tracking code batches these measurement data at regular time intervals and transmits them to the server. The present system executes a query using a structured query language to a back-end database of an electronic commerce site. The present system extracts purchase history data. The present system collects a usage log using a software development kit incorporated in the application on the terminal side. The software development kit hooks a life cycle event of the application, and accumulates log data in a background. The present system uploads the accumulated log data to the server at a timing when a network connection is established. A technical effect by this processing is realization of seamless and efficient data collection from diverse platforms. The present system significantly reduces a load on the server side and a communication band by performing initial data processing on the terminal side utilizing edge computing technology. As a specific application field, the present system is applicable to an integrated customer data platform in omnichannel retailing.

The data integration unit has a function of centrally managing and integrating the diverse data transmitted from the data collection unit, and executes identification processing on data having different ID systems, such as an account ID of an SNS, a member ID of an EC site, a user ID of an application, and a cookie ID of a web browser, using common attributes such as an e-mail address, a telephone number, a terminal identifier, location information, an IP address, and behavior patterns, to integrate them as data of the same person. For example, when registering for a plurality of services using the same e-mail address, they are combined into one customer profile. Regarding differences in data formats, date notations (YYYY/MM/DD, MM-DD-YYYY, etc.), currency units (yen, dollar, etc.), and notation fluctuations of category names (smartphone, sumaho, etc.) are automatically unified. Regarding duplicate data, when the same purchase history or browsing history is acquired from a plurality of data sources, timestamps and contents are compared to eliminate duplication. As noise removal processing, abnormally expensive purchase data, a non-existent product ID, and an abnormal access frequency (access by a bot, etc.) are detected, and excluded or corrected. When a missing value exists, for example, when a purchase date and time of a purchase history is missing, it is estimated and complemented from other behavior histories or data of similar customers using a generative AI. Further, when the posted content of the SNS is unclear, semantic analysis by natural language processing is performed to estimate a related attribute. Specifically, the present system comprises the data integration unit. The data integration unit executes a data pipeline operating on a distributed processing framework. The data integration unit implements an entity resolution algorithm for executing the identification processing. The entity resolution algorithm uses a machine learning-based record linkage model. Input data to the record linkage model is a feature vector calculated from a pair of customer records extracted from two different data sources. The feature vector includes a similarity index such as a Levenshtein distance or a Jaro-Winkler distance of a character string. As a specific example of the input data, a vector including a similarity of names, a matching degree of telephone numbers, and a proximity of IP addresses can be cited. As another specific example, a vector including a matching degree of terminal identifiers and an overlapping degree of location information can be cited. The record linkage model determines whether or not the pair is the same person using a random forest classifier. Output data from the record linkage model is a predicted probability value of binary classification indicating a probability of being the same person. The output value indicates a high probability of, for example, 0.98. The data integration unit merges the records when this probability value exceeds a threshold value. The data integration unit executes semantic mapping using a natural language processing model in unification processing of a data format. The data integration unit maps a category name with notation fluctuation to a standard ontology. The data integration unit performs high-speed existence confirmation using a Bloom filter in deduplication processing. The data integration unit specifies an outlier using an isolation forest algorithm in abnormality detection processing. The data integration unit executes a machine learning model based on multiple imputation in missing value complementation processing. Input data to the machine learning model is a feature matrix including a missing value. Output data from the machine learning model is a complete feature matrix in which a missing portion is filled with an estimated value. A technical effect by this processing is realization of high-speed and highly accurate data cleansing for a large-scale and non-uniform data set. The present system eliminates the need for conventional manual rule setting and dramatically improves data quality by applying a machine learning algorithm to each stage of a data integration process. As a specific application field, the present system is applicable to a data preprocessing engine in a customer data platform.

The data analysis unit analyzes the integrated customer data set from multiple angles using a generative AI, and extracts various attribute information such as interests, purchasing tendencies, behavior patterns, usage channels, active time zones, a lifestyle, a purchase cycle, a brand preference, and a price sensitivity for each customer. For example, posted contents and a comment history of an SNS are analyzed by natural language processing to extract interests (travel, gourmet, sports, home appliances, fashion, etc.) of a customer. From a website browsing history, categories of browsed pages and search words are analyzed to specify products and services in which the customer is currently interested. From a purchase history, a category, a price range, a purchase frequency, a purchase cycle, a brand preference, a price sensitivity, and the like of purchased products are extracted. For example, when a subscription service of a fixed amount is used every month, it is determined that a regular purchase intention is strong. From an application usage status, a frequently used function, a usage time zone, and an action in an application (adding to a cart, adding to a wish list, posting a review, etc.) are analyzed to estimate behavior patterns and a lifestyle of the customer. For example, when the shopping function is used in the daytime on weekdays and the video viewing function is used at night, it is determined that information gathering is strong in the daytime and entertainment orientation is strong at night. These profiling processes are automatically executed by the generative AI learning a huge amount of past data and combining methods such as pattern recognition, clustering, attribute estimation, time-series analysis, and abnormality detection. For example, a purchase cycle of the customer can be predicted by time-series analysis, and a next purchase timing can be estimated. Specifically, the present system comprises the data analysis unit. The data analysis unit executes a deep learning model on a parallel computing cluster using a graphics processing unit. The data analysis unit has a multimodal neural network for extracting interests of the customer. Input data to the multimodal neural network is a composite tensor obtained by combining a text feature vector, an image feature vector, and a time-series tensor of a behavior history. As a specific example of the input data, a tensor obtained by combining an embedding vector of a text explanatory note of a product browsed by the customer, a convolutional feature of a product image, and an array of the number of times of browsing in the past one week can be cited. As another specific example, a tensor obtained by combining a posted text vector of social media and a visual feature of an image attached to a post can be cited. The multimodal neural network learns a correlation between different modalities using a cross-attention mechanism. Output data from the multimodal neural network is an embedding vector indicating multidimensional coordinates in a potential preference space of the customer. The output value is, for example, a 256-dimensional floating-point array. The data analysis unit performs a search for similar customers and scoring of a recommended item using this embedding vector. The data analysis unit executes a survival time analysis model for predicting a purchase cycle. Input data to the survival time analysis model is a feature matrix including a past purchase interval and a customer attribute. Output data from the survival time analysis model is a hazard function indicating a purchase occurrence probability with respect to an elapsed time. The data analysis unit calculates a next optimal approach time based on this hazard function. The data analysis unit executes a topic model based on latent Dirichlet allocation for extracting a brand preference and a price sensitivity. A technical effect by this processing is advanced context understanding from multidimensional and heterogeneous data and improvement of prediction accuracy. The present system automatically extracts deep customer insights that cannot be obtained from a single data source by using multimodal learning. As a specific application field, the present system is applicable to a recommendation engine of an electronic commerce site requiring advanced personalization.

The advertisement generation and distribution unit learns a customer profile, an advertisement distribution history, and performance indicators using a generative AI, and automatically generates an optimal advertisement creative (an image, text, a video, etc.) for each customer. For example, for a customer who likes traveling, a landscape image of a popular travel destination or a banner advertisement of a travel plan is automatically generated using an image generation technology by the generative AI, and a catchphrase such as “Limited time only! Summer vacation travel special” is automatically created using a text generation technology. For a customer interested in a smartphone, a specification comparison table of the latest model or an introduction video of an accessory is automatically generated. For a fashion-oriented customer, a coordination image combining trend items of this season or a recommended comment by a stylist is automatically generated. As a distribution channel of an advertisement, there are an SNS, an e-mail, a push notification, a web advertisement, an in-app advertisement, and the like, and the generative AI learns a usage tendency and a past reaction for each customer, and automatically selects an optimal channel and distribution timing. For example, if an active time on an SNS is at night, an SNS advertisement is distributed at night, and an e-mail advertisement is transmitted in the morning to a customer having a high e-mail open rate. On the terminal side, the distributed advertisement is displayed, and the customer can perform an action such as browsing, clicking, or purchasing the advertisement through a user interface. For example, when an advertisement banner is clicked, a transition is made to a product detail page or a purchase page, and a purchase procedure can be performed with one click. Specifically, the present system comprises the advertisement generation and distribution unit. The advertisement generation and distribution unit has a dynamic creative optimization engine. The dynamic creative optimization engine generates and assembles each component of an advertisement in real time using a generative artificial intelligence model. Input data to the generative artificial intelligence model is a conditioning tensor including an embedding vector of the customer output from the data analysis unit, metadata of a product, and distribution context information. As a specific example of the input data, a tensor including a fashion preference vector of the customer, price information of a specific jacket, and current weather information can be cited. As another specific example, a tensor including a gadget preference vector of the customer, specification information of a smartphone, and category information of a distribution destination website can be cited. The generative artificial intelligence model generates a banner image using a conditional generative adversarial network. Output data from the generative artificial intelligence model is an image tensor having a layout, a color, and typography optimized for the preference of the customer. The output value is, for example, image data of a layout based on a blue color preferred by the customer and considering line-of-sight guidance. The advertisement generation and distribution unit generates personalized text using a large language model. The advertisement generation and distribution unit dynamically renders the generated image and text using a hypertext markup language and a cascading style sheet. The advertisement generation and distribution unit executes a deep reinforcement learning agent for determining a distribution channel and timing. Input data to the deep reinforcement learning agent is a current state vector of the customer. Output data from the deep reinforcement learning agent is an array of Q values indicating action values for a plurality of distribution channels. The advertisement generation and distribution unit selects a channel and timing having a maximum Q value to distribute the advertisement. A technical effect by this processing is generation of infinite variations of an advertisement creative and realization of ultimate personalization for an individual customer. The present system completely automates an entire process from production to distribution of an advertisement and dramatically improves a conversion rate by integrating a generative artificial intelligence and reinforcement learning. As a specific application field, the present system is applicable to a marketing automation platform in a cross-channel.

The performance monitoring and feedback unit automatically aggregates performance indicators such as the number of impressions, the number of clicks, a click rate, the number of conversions, a conversion rate, a stay time, a bounce rate, a unit purchase price, a repeat rate, and sales via an advertisement after advertisement distribution in real time, and visualizes them on a dashboard. For example, an effect is analyzed for each advertisement, for each customer segment, for each distribution channel, and for each time zone, and it is determined which advertisement was effective for which customer segment, and which channel or timing was most effective. The generative AI analyzes these performance data, and automatically and continuously optimizes a selection logic of an advertisement content, a distribution timing, and a distribution channel. For example, when the click rate is low, the advertisement creative is changed, a distribution time zone is adjusted, or discount campaign information is added. Further, an A/B test or a multivariate test is automatically executed to select an advertisement pattern having the highest effect. For example, a plurality of advertisements using different catchphrases or images for the same product are distributed, and which pattern shows the highest conversion rate is automatically determined. Specifically, the present system comprises the performance monitoring and feedback unit. The performance monitoring and feedback unit asynchronously processes a large amount of event data using a distributed messaging system. The performance monitoring and feedback unit calculates performance indicators in real time using a complex event processing engine. The performance monitoring and feedback unit stores the calculated indicators in a time-series database. The performance monitoring and feedback unit executes a deep neural network model for evaluating performance of an advertisement. Input data to the deep neural network model is a multidimensional tensor including a visual feature of an advertisement, an embedding vector of text, a distribution context, and a real-time aggregation indicator. As a specific example of the input data, a tensor including an image feature of a banner image, a context vector of a catchphrase, a distribution time zone, and a click rate in the past ten minutes can be cited. As another specific example, a tensor including a frame feature of a video advertisement, a text vector of voice, an application category of a distribution destination, and a conversion rate can be cited. The deep neural network model learns a non-linear interaction between these features. Output data from the deep neural network model is a predicted value indicating a future expected revenue of the advertisement. The output value indicates that, for example, an expected revenue per impression is 0.05 dollars. The performance monitoring and feedback unit dynamically adjusts a distribution weight of the advertisement based on this predicted value. The performance monitoring and feedback unit automates a multivariate test using a Bayesian optimization algorithm. The Bayesian optimization algorithm updates a posterior distribution of an objective function using Gaussian process regression, and determines a next test parameter that maximizes an acquisition function. A technical effect by this processing is autonomous optimization of an advertisement campaign and minimization of an opportunity loss. The present system instantaneously adapts to a change in a market or a reaction of a customer by combining a real-time feedback loop and an advanced optimization algorithm. As a specific application field, the present system is applicable to an advertisement distribution optimization system in a real-time bidding environment.

The user interface unit operates on the terminal side, and provides a screen and an operation means that allow the customer to intuitively perform an action such as browsing, clicking, purchasing, or transmitting feedback of an advertisement. For example, it is possible to make a transition to a detail page by tapping an advertisement banner, install a feedback button such as “interested” or “not interested” for an advertisement, or display a questionnaire or a review posting screen regarding an advertisement content. Specifically, the present system comprises the user interface unit. The user interface unit is implemented as a native application operating on an operating system of a terminal or a front-end module executed in a web browser. The user interface unit renders advertisement data received from the server on a screen. The user interface unit registers an event listener for detecting a touch operation or a mouse operation of the customer. The user interface unit recognizes a gesture such as a swipe operation or a long-press operation on an advertisement banner. The user interface unit executes a specific action based on the recognized gesture. The user interface unit displays an interactive widget for collecting explicit feedback from the customer. The widget is a button group including options such as “hide this advertisement” and “see more similar advertisements”, for example. The user interface unit generates input data when the customer presses a button. As a specific example of the input data, a JSON object including an advertisement identifier and a feedback type (negative or positive) can be cited. As another specific example, a data structure including an answer content of a questionnaire and a timestamp can be cited. The user interface unit transmits this input data to the server using asynchronous communication. The user interface unit adopts an optimistic UI pattern that updates drawing of a screen without waiting for a response from the server. A technical effect by this processing is improvement of a customer experience and efficient collection of high-quality teacher data. The present system continuously acquires feedback data indispensable for improvement of a machine learning model while reducing frustration of the customer by providing an intuitive and highly responsive interface. As a specific application field, the present system is applicable to a native advertisement display module in an application for a smartphone.

The security and privacy management unit is responsible for encryption of customer data, access authority management, anonymization processing, privacy setting management, and the like, and realizes an operation conforming to a personal information protection law and various regulations. For example, information capable of specifying an individual is hashed, and only anonymized data is used for advertisement distribution and analysis. A function allowing the customer to opt out of data collection and advertisement distribution is also provided on the terminal side. Specifically, the present system comprises the security and privacy management unit. The security and privacy management unit cooperates with a security information and event management system that monitors a data flow of the entire system. The security and privacy management unit uses a public key infrastructure using an elliptic curve cryptography algorithm in encryption processing of customer data. The security and privacy management unit applies transparent data encryption to stored data in a database. The security and privacy management unit implements a hybrid authorization model combining role-based access control and attribute-based access control in access authority management. The security and privacy management unit executes a differential privacy algorithm in anonymization processing. Input data to the differential privacy algorithm is a raw data set to be aggregated and a privacy budget parameter. As a specific example of the input data, a data set for calculating an average purchase amount of customers in a specific region and a value of a privacy budget epsilon can be cited. As another specific example, a data set of the number of advertisement clicks in a specific age group can be cited. The differential privacy algorithm adds noise following a Laplace distribution or a Gaussian distribution to a calculation result. Output data from the differential privacy algorithm is an aggregation result to which noise is added in a state where specification of an individual is mathematically impossible. The output value is, for example, a numerical value obtained by adding random noise to an actual average purchase amount. The security and privacy management unit provides this output data to the data analysis unit and the performance monitoring and feedback unit. The security and privacy management unit provides a dedicated application programming interface endpoint for processing an opt-out request from the terminal side. A technical effect by this processing is resolution of a trade-off between advanced data utilization and strict privacy protection. The present system maintains statistical usefulness necessary for learning of a machine learning model while mathematically guaranteeing privacy of an individual by implementing a state-of-the-art cryptographic theory such as differential privacy. As a specific application field, the present system is applicable to a global data analysis platform that needs to comply with strict privacy laws and regulations such as a general data protection regulation.

As a specific example of a prompt sentence to be read by a generative AI when carrying out the present invention, “extract interests, purchasing tendencies, active time zones, and usage channels based on an SNS post, a website browsing history, a purchase history, and an application usage status of this customer, and propose an optimal advertisement content and distribution timing”, “automatically generate a banner image and a catchphrase of a travel special based on this customer profile”, “analyze advertisement distribution data and performance indicators in the past 30 days, and propose an advertisement creative and a distribution strategy for maximizing a click rate and a conversion rate”, “select the most effective advertisement pattern based on A/B test results of a plurality of advertisement patterns, and reflect it in next distribution”, and the like can be cited. Specifically, the present system comprises a prompt engineering module. The prompt engineering module dynamically constructs an input prompt for a large language model. The prompt engineering module generates a prompt character string by combining context data of the customer and an instruction from the system. Input data to the prompt engineering module is structured customer profile data and a task definition template. As a specific example of the input data, JSON data including an age, a gender, and a past purchase history of the customer, and a template “generate an optimal advertisement catchphrase for this customer” can be cited. As another specific example, a list of a website browsing history in the past one week and a template “extract current interests of this customer with three keywords” can be cited. The prompt engineering module converts these data into a prompt sentence of a natural language. The prompt engineering module inputs the generated prompt sentence to the large language model. Output data from the large language model is a text character string generated in accordance with an instruction of the prompt. As a specific example of the output value, a character string of an analysis result “interests: outdoor, camera, automobile. optimal distribution timing: morning on weekend” can be cited. As another specific example, a character string of a strategy proposal “in order to maximize a click rate, an image should be based on a blue color, and a catchphrase should include a word ‘limited’” can be cited. The present system inputs this output character string to a syntax analyzer, and reconverts it into structured data processable by a subsequent system module. A technical effect by this processing is to seamlessly integrate an inference capability of the large language model into an automated pipeline of the system. The present system utilizes a flexible inference result by a natural language for deterministic system control by combining dynamic prompt generation and structured analysis of an output. As a specific application field, the present system is applicable to an automatic planning and execution system of a marketing strategy utilizing an artificial intelligence.

As described above, the system according to the present embodiment includes a data collection unit, a data integration unit, a data analysis unit, an advertisement generation and distribution unit, a performance monitoring and feedback unit, a user interface unit, and a security and privacy management unit, and the respective units operate in cooperation to automatically realize highly accurate personalized advertisement distribution optimized for each customer in real time.

### Implementation Steps

Step 1: Multi-channel customer data collection. First, posted contents, a like history, a comment history, a follow relationship, a trend topic participation status, and the like of a customer are acquired on the server side using an API of an SNS. In addition, a detailed website browsing history such as which website the customer visited, which page the customer browsed and for how long, which link the customer clicked, and which search word the customer input is collected using a web browser extension function, a cookie, and a tracking tag on the terminal side, and is transmitted to the server. Furthermore, by linking with a database of an EC site or a POS system, a purchase history such as a product name, a category, a purchase date and time, a purchase amount, a purchase frequency, a purchase channel, a return history, and a review posting history purchased by the customer in the past is acquired. In addition, an application on the terminal side generates a usage log, and detailed behavior data such as which application is activated and how often, which function (chat, video viewing, shopping, news browsing, coupon usage, point acquisition, etc.) is used in the application and in which time zone, which button or link is tapped, and a purchase or billing history in the application is transmitted to the server. Specifically, the data collection unit adopts a distributed processing architecture. The data collection unit acquires streaming data from each endpoint using an asynchronous communication protocol. The data collection unit inputs the acquired text data to a natural language processing model. The natural language processing model is based on a transformer architecture. Input data to the natural language processing model is a word embedding vector array. For example, the input data is a 512-dimensional token vector. The natural language processing model analyzes a context using a self-attention mechanism. An output of the natural language processing model is a probability distribution of a sentiment score and a topic classification. For example, output data is a probability value of 0.95 for a travel topic. The data collection unit transfers this output result to the subsequent data integration unit. With this configuration, the system converts a huge amount of unstructured data into structured data in real time. As a result, the system exhibits a technical effect of significantly reducing latency of data processing. As a specific application field, the system is applied to real-time customer behavior tracking in a large-scale e-commerce platform.
Step 2: Data integration and cleansing. On the server side, data having different ID systems, such as an account ID of an SNS, a member ID of an EC site, a user ID of an application, and a cookie ID of a web browser, are subjected to identification processing using common attributes such as an e-mail address, a telephone number, a terminal identifier, location information, an IP address, and behavior patterns, and are integrated as data of the same person. Regarding differences in data formats, date notations, currency units, and notation fluctuations of category names are automatically unified, and regarding duplicate data, timestamps and contents are compared to eliminate duplication. As noise removal processing, abnormally expensive purchase data, a non-existent product ID, and an abnormal access frequency are detected, and are excluded or corrected. When a missing value exists, a generative AI is used to estimate and complement it from other behavior histories or data of similar customers, for example, when a purchase date and time of a purchase history is missing. Specifically, the data integration unit executes the identification processing using a graph neural network. The data integration unit generates graph structure data in which attribute information of each customer is a node and a common attribute is an edge. Input data to the graph neural network are a node feature matrix and an adjacency matrix. For example, the input data is a 256-dimensional vector including a hash value of an e-mail address. The graph neural network learns a relationship between nodes using a message passing algorithm. An output of the graph neural network is a similarity score indicating a probability that each node belongs to the same person. For example, output data is a numerical value of 0.98 indicating a probability that two accounts are the same person. The data integration unit connects the nodes to each other when the similarity score exceeds a predetermined threshold. Furthermore, the data integration unit uses a generative adversarial network for missing value complementation. A generator of the generative adversarial network receives an incomplete purchase history vector as an input. The generator adds a noise vector sampled from a latent space to generate a complete purchase history vector. A discriminator of the generative adversarial network compares the generated vector with an actual vector to determine authenticity. With this configuration, the system dramatically improves integration accuracy of heterogeneous mixed data. As a result, the system exhibits a technical effect of reducing an error caused by noise in subsequent profiling processing. As a specific application field, the system is applied to construction of an integrated customer database of a retail company developing a plurality of brands.
Step 3: Customer profiling and attribute extraction (utilization of generative AI). The integrated customer data set on the server side is input to a generative AI, and attribute information such as interests, purchasing tendencies, behavior patterns, usage channels, active time zones, a lifestyle, a purchase cycle, a brand preference, and price sensitivity for each customer is extracted. For example, posted contents and a comment history of an SNS are analyzed by natural language processing to extract interests (travel, gourmet, sports, home appliances, fashion, etc.) of the customer. From a website browsing history, categories of browsed pages and search words are analyzed to specify products and services in which the customer is currently interested. Specific examples of a prompt sentence to be read by the generative AI include “Extract interests, purchasing tendencies, active time zones, and usage channels based on SNS posts, a website browsing history, a purchase history, and an application usage status of this customer”, “Predict a next purchase timing from the purchase history and behavior patterns of this customer”, and the like. Specifically, the data analysis unit executes customer profiling using a large language model. The large language model is a transformer-based neural network having tens of billions of parameters. The data analysis unit converts the integrated customer data set into a time-series event sequence. The data analysis unit tokenizes this event sequence and adds positional encoding to generate an input tensor. Input data to the large language model is this multidimensional input tensor. For example, the input data is a 1024-dimensional vector array in which a purchase history and a website browsing history for the past 30 days are combined. The large language model infers a potential attribute of the customer through an autoregressive decoding process. An output of the large language model is a multidimensional feature vector and structured text data indicating the interests and purchasing tendencies of the customer. For example, output data is a score of 0.85 indicating a degree of interest in travel, and a timestamp indicating a next predicted purchase time. The data analysis unit stores this output result in a customer profile database. The data analysis unit supplies the extracted feature vector to a subsequent advertisement generation unit. With this configuration, the system automatically extracts complex behavior patterns that are difficult for a human analyst to discover in a high-dimensional space. As a result, the system exhibits a technical effect of significantly improving resolution and prediction accuracy of profiling. As a specific application field, the system is applied to a financial product recommendation system based on personal life event prediction in a financial institution.
Step 4: Personalized advertisement generation (utilization of generative AI). A customer profile, an advertisement distribution history, and performance indicators are learned using a generative AI, and an optimal advertisement creative (an image, text, a video, etc.) is automatically generated for each customer. For example, for a customer who likes traveling, a landscape image of a popular travel destination and a banner advertisement of a travel plan are automatically generated using an image generation technology by the generative AI, and a catchphrase such as “Limited time only! Summer vacation travel special feature” is automatically created using a text generation technology. Specific examples of a prompt sentence to be read by the generative AI include “Automatically generate a banner image and a catchphrase of a travel special feature based on this customer profile”, “Automatically generate a comparison table and recommended points of the latest models for a customer interested in smartphones”, and the like. Specifically, the advertisement generation and distribution unit uses a multimodal generative artificial intelligence combining a diffusion model and an autoregressive language model. The advertisement generation and distribution unit acquires a feature vector extracted from a customer profile database as conditioning data. Input data to the diffusion model are a random noise image tensor and the conditioning data. For example, the input data is a 256-pixel square noise tensor and a 512-dimensional text embedding vector indicating a love of travel. The diffusion model removes noise stepwise through a reverse diffusion process to generate a high-resolution advertisement image tensor. Input data to the autoregressive language model are the conditioning data and a feature vector of the generated image. The autoregressive language model generates an optimal catchphrase character string using a beam search algorithm. An output of the multimodal generative artificial intelligence is a pair of generated image data and text data. For example, output data is a structured object including a landscape image of Hawaii and text of a summer vacation limited special plan. The advertisement generation and distribution unit registers this output result in a queue of an advertisement distribution server. With this configuration, the system dynamically generates a unique advertisement creative perfectly matching the preference of each individual customer in real time. As a result, the system exhibits a technical effect of maximizing relevance of an advertisement while reducing a human cost of creative production. As a specific application field, the system is applied to individualized digital marketing of a dynamic package tour in a travel agency.
Step 5: Advertisement distribution channel and timing optimization (utilization of generative AI). A generative AI learns a usage tendency and a past reaction for each customer, and automatically selects an optimal channel and distribution timing from among an SNS, an e-mail, a push notification, a web advertisement, an in-app advertisement, and the like. For example, if an active time on an SNS is at night, an SNS advertisement is distributed at night, and an e-mail advertisement is transmitted in the morning to a customer having a high e-mail open rate. Specific examples of a prompt sentence to be read by the generative AI include “Propose an optimal distribution channel and distribution timing from a behavior history and a past advertisement reaction of this customer”, “Compare effects of a plurality of distribution channels and select a channel from which the highest click rate can be expected”, and the like. Specifically, the advertisement generation and distribution unit optimizes a distribution strategy using a deep reinforcement learning algorithm. The deep reinforcement learning algorithm functions as an agent based on a Markov decision process. Input data to the deep reinforcement learning algorithm is a state vector indicating a current state of the customer. For example, the input data is a 128-dimensional numerical vector including the latest login time of the customer, a past reaction rate by channel, and a current day of the week and time. The deep reinforcement learning algorithm calculates an expected reward of each action using a policy gradient method. An output of the deep reinforcement learning algorithm is an action probability distribution indicating an optimal distribution channel and distribution timing. For example, output data is a tensor indicating that a probability of distributing via a social networking service at 8:00 p.m. is 0.92. The advertisement generation and distribution unit selects a channel and a timing with the highest probability based on this output result, and registers them in a distribution scheduler. The deep reinforcement learning algorithm receives an actual customer reaction as a reward signal, and updates a weight of a neural network by temporal difference learning. With this configuration, the system eliminates a static rule-based distribution schedule and realizes dynamic and adaptive distribution control. As a result, the system exhibits a technical effect of maximizing visibility of an advertisement and minimizing advertisement fatigue of a customer. As a specific application field, the system is applied to automatic operation of an omnichannel campaign in a general retail business having diverse customer contact points.
Step 6: Advertisement distribution and user interface display. Based on an advertisement content, a distribution channel, and a timing determined on the server side, an advertisement is distributed to an application, a web browser, an e-mail client, or the like on the terminal side, and a user interface that allows a customer to intuitively perform an action such as browsing, clicking, purchasing, and feedback transmission of the advertisement is displayed. For example, a transition to a detailed page is made by tapping an advertisement banner, a feedback button such as “interested” or “not interested” for an advertisement is installed, or a questionnaire or review posting screen regarding an advertisement content is displayed. Specifically, the application on the terminal side acquires advertisement data from the server using asynchronous communication. The application temporarily stores the acquired advertisement data in a local cache memory. The application includes a rendering engine that dynamically calculates a layout of an advertisement according to a screen resolution and an orientation of a device. The rendering engine executes drawing by hardware acceleration using a graphics processing unit. The application implements an event listener that monitors a touch event of a user. The event listener acquires coordinate data and pressure when the user taps an advertisement banner. The application records these interaction data together with a timestamp as a structured log file. The application periodically transmits this log file to the server through a background process. With this configuration, the system provides a smooth user experience without being affected by a network delay. As a result, the system exhibits a technical effect of reducing a user drop-off rate and enabling accurate measurement of an interaction. As a specific application field, the system is applied to a native advertisement display system in a mobile game requiring high responsiveness.
Step 7: Performance monitoring and feedback optimization (utilization of generative AI). Performance indicators such as the number of impressions, the number of clicks, a click rate, the number of conversions, a conversion rate, a stay time, a drop-off rate, a unit purchase price, a repeat rate, and sales via an advertisement after advertisement distribution are automatically aggregated in real time, and a generative AI analyzes these performance data to automatically and continuously optimize a selection logic of an advertisement content, a distribution timing, and a distribution channel. For example, when a click rate is low, an advertisement creative is changed, a distribution time zone is adjusted, or discount campaign information is added. Specific examples of a prompt sentence to be read by the generative AI include “Analyze advertisement distribution data and performance indicators for the past 30 days, and propose an advertisement creative and a distribution strategy for maximizing a click rate and a conversion rate”, “Select the most effective advertisement pattern based on A/B test results of a plurality of advertisement patterns, and reflect it in the next distribution”, and the like. Specifically, the performance monitoring and feedback unit aggregates data in real time using a stream processing engine. The performance monitoring and feedback unit stores the aggregated performance indicators in a time-series database. The performance monitoring and feedback unit performs future prediction of performance using a long short-term memory network which is a kind of recurrent neural network. Input data to the long short-term memory network is a time-series tensor of past performance indicators. For example, the input data is a three-dimensional tensor including an hourly click rate and conversion rate for the past seven days. The long short-term memory network learns a time-series dependency relationship while updating a hidden state and a cell state. An output of the long short-term memory network is a predicted performance score at a next time step. For example, output data is numerical data that a predicted conversion rate when a current advertisement creative is maintained is 0.05. The performance monitoring and feedback unit issues a trigger signal instructing a generative artificial intelligence to regenerate an advertisement creative when this predicted score falls below a target value. With this configuration, the system constructs a closed-loop control system that detects a decrease in performance in advance and autonomously corrects a trajectory. As a result, the system exhibits a technical effect of continuously and automatically maximizing return on investment of an advertisement campaign. As a specific application field, the system is applied to a large-scale digital advertisement operation platform requiring strict management of a budget consumption speed and a unit acquisition cost.

### Specific Use Case

For example, a case will be described in which a company providing a communication service distributes a personalized advertisement optimized for each customer using the system of the present invention. First, the data collection unit acquires posts related to topics such as “travel”, “outdoors”, and “home appliances”, a “like” history, a comment history, a follow relationship, and a trend topic participation status of a customer through an API of an SNS. Further, using a web browser extension function and a tracking tag on the terminal side, a detailed website browsing history such as a history of the customer inputting search words such as “cheap smartphone”, “overseas travel insurance”, and “latest home appliances” and browsing related websites and product pages, which banner advertisement the customer clicked, and which page the customer browsed for how long is collected. In addition, by linking with a database of an EC site or a POS system, a purchase history such as a product name, a category, a purchase date and time, a purchase amount, a purchase frequency, a purchase channel, a return history, and a review posting history of a smartphone, an accessory, travel goods, a home appliance, and the like purchased by the customer in the past is acquired. Furthermore, an application on the terminal side generates a usage log, and transmits detailed behavior data such as which application the customer starts at what frequency, which function (chat, video viewing, shopping, news browsing, coupon usage, point acquisition, etc.) the customer uses in the application in what time zone, which button or link the customer taps, and a purchase or billing history in the application to the server. Specifically, the data collection unit asynchronously collects data from each data source via a distributed message queuing system. The data collection unit parses structured text data acquired from an application programming interface of a social networking service. The data collection unit receives an operation event log of a document object model transmitted from the web browser extension function. The data collection unit inputs these raw data to a preprocessing module. The preprocessing module removes stop words from the text data using a natural language processing technology, and executes a stemming process. Input data to the preprocessing module is a character string array including a search query of the customer and text of a browsed page. For example, the input data is a character string of “cheap smartphone comparison latest”. An output of the preprocessing module is a token list of normalized words. For example, output data is an array of tokens of “cheap”, “smartphone”, “comparison”, and “latest”. The data collection unit inputs this token list to a word embedding model, and converts it into a fixed-dimensional dense vector. With this configuration, the system converts unstructured data in various formats into a representation on a unified vector space. As a result, the system exhibits a technical effect of significantly improving calculation efficiency and processing speed in a subsequent machine learning model. As a specific application field, the system is applied to construction of an integrated customer data platform for the purpose of cross-selling of a plurality of services in a communication carrier.

The data integration unit executes identification processing on data having different ID systems, such as an account ID of an SNS, a member ID of an EC site, a user ID of an application, and a cookie ID of a web browser, using common attributes such as an e-mail address, a telephone number, a terminal identifier, location information, an IP address, and behavior patterns, and integrates them as data of the same person. Regarding differences in data formats, date notations, currency units, and notational fluctuations of category names are automatically unified, and regarding duplicate data, time stamps and contents are compared to eliminate duplication. As a noise removal process, abnormally expensive purchase data, a non-existent product ID, and an abnormal access frequency are detected, and excluded or corrected. When a missing value exists, for example, when a purchase date and time of a purchase history is missing, it is estimated and complemented from other behavior histories and data of similar customers using the generative AI. Specifically, the data integration unit improves the accuracy of the identification processing using a gradient boosting model based on decision tree ensemble learning. The data integration unit configures a pair of attributes extracted from different data sources as a feature vector. Input data to the gradient boosting model is a feature vector including a similarity score of each attribute between two records. For example, the input data is a 64-dimensional numerical vector including a Levenshtein distance of an e-mail address, a match flag of a telephone number, and a subnet match degree of an IP address. The gradient boosting model is learned so as to minimize a prediction error by connecting a plurality of weak learners in series. An output of the gradient boosting model is a prediction probability of binary classification indicating a probability that two records belong to the same customer. For example, output data is a floating-point number indicating that the probability of being the same person is 0.99. The data integration unit merges the records based on this prediction probability, and assigns a unique global identifier. Furthermore, the data integration unit detects an abnormal value and removes noise using an autoencoder. The autoencoder learns data of a normal purchase pattern, compresses input data into a low-dimensional latent space, and then restores it to the original dimension. The data integration unit calculates a reconstruction error between the input data and the restored data, and excludes data whose error exceeds a threshold value as an abnormal value. With this configuration, the system automates ambiguous data match determination, which cannot be handled by a complex rule base, with high accuracy. As a result, the system exhibits a technical effect of dramatically improving the quality of a customer database and preventing erroneous profiling. As a specific application field, the system is applied to a system integration project of a giant communication company that needs to integrate a plurality of customer databases due to a merger or acquisition.

The data analysis unit analyzes the integrated customer data set from multiple angles using the generative AI, and extracts attribute information such as interests, purchasing tendencies, behavior patterns, usage channels, active time zones, a lifestyle, a purchase cycle, a brand preference, and price sensitivity for each customer. For example, posted contents and a comment history of an SNS are analyzed by natural language processing to extract interests (travel, gourmet, sports, home appliances, fashion, etc.) of a customer. From a website browsing history, categories of browsed pages and search words are analyzed to specify products and services in which the customer is currently interested. From a purchase history, a category, a price range, a purchase frequency, a purchase cycle, a brand preference, price sensitivity, and the like of purchased products are extracted. From an application usage status, frequently used functions, usage time zones, and actions in the application (adding to a cart, adding to a wish list, posting a review, etc.) are analyzed to estimate behavior patterns and a lifestyle of the customer. Specific examples of a prompt sentence to be read by the generative AI include “Extract interests, purchasing tendencies, active time zones, and usage channels based on SNS posts, a website browsing history, a purchase history, and an application usage status of this customer”, “Predict the next purchase timing from the purchase history and behavior patterns of this customer”, and the like. Specifically, the data analysis unit executes attribute extraction by fine-tuning a pre-trained large language model based on a transformer architecture. The data analysis unit converts the integrated customer data set into a time-series event token sequence. Input data to the large language model is a multidimensional tensor obtained by adding positional encoding to this event token sequence. For example, the input data is a 2048-dimensional token embedding matrix in which a purchase history, an application start log, and a search query for the past six months are arranged in chronological order. The large language model uses a multi-head self-attention mechanism to assign a high weight to an important event that most affects current interests from among past behavior histories. An output of the large language model is a probability distribution and a feature vector indicating attributes and predicted behaviors of the customer. For example, output data is a score indicating that a probability that the next smartphone replacement timing is within three months is 0.85, and a one-hot vector indicating belonging to a cluster of high-end model orientation. The data analysis unit updates and stores this output result in a database as a profile vector of the customer. With this configuration, the system executes advanced inference that deeply understands the context and order relationship of behaviors, rather than mere statistical aggregation. As a result, the system exhibits a technical effect of predicting potential needs of a customer before they become apparent, and enabling a proactive proposal. As a specific application field, the system is applied to an automatic planning system for early detection of a potential cancellation group and a retention measure in a communication service.

The advertisement generation and distribution unit learns a customer profile, an advertisement distribution history, and performance indicators using the generative AI, and automatically generates an optimal advertisement creative (an image, text, a video, etc.) for each customer. For example, for a customer who likes traveling, a landscape image of a popular travel destination or a banner advertisement of a travel plan is automatically generated using an image generation technology by the generative AI, and a catchphrase such as “Limited time only! Summer vacation travel special” is automatically created using a text generation technology. For a customer interested in smartphones, a specification comparison table of the latest models and an introduction video of accessories are automatically generated. For a fashion-oriented customer, a coordination image combining trend items of this season and a recommended comment by a stylist are automatically generated. Specific examples of a prompt sentence to be read by the generative AI include “Automatically generate a banner image and a catchphrase for a travel special based on this customer profile”, “Automatically generate a comparison table and recommended points of the latest models for a customer interested in smartphones”, and the like. Specifically, the advertisement generation and distribution unit utilizes an image generation pipeline integrating a generative adversarial network and a conditional variational autoencoder. The advertisement generation and distribution unit receives the profile vector of the customer output from the data analysis unit as a conditioning input. Input data to the conditional variational autoencoder is a tensor of an advertisement image that has recorded a high click rate in the past and the profile vector. For example, the input data is a 512-pixel square RGB image tensor and a 256-dimensional attribute vector indicating a love for travel. The conditional variational autoencoder maps the input image to a probability distribution in a latent space, and samples a new latent vector therefrom. A generator of the generative adversarial network receives this latent vector and the profile vector as inputs, and generates a new advertisement image tensor. A discriminator of the generative adversarial network determines whether the generated image is at a level indistinguishable from a real advertisement image, and updates weights of the generator. An output of the image generation pipeline is high-resolution image data optimized for the customer's preference. For example, output data is a rendering image of the latest smartphone based on a blue color preferred by the customer. The advertisement generation and distribution unit synthesizes the generated image data and text data separately generated by a language model to construct a final advertisement creative. With this configuration, the system instantaneously generates a high-quality advertisement creative having infinite variations without human intervention. As a result, the system exhibits a technical effect of preventing depletion of creatives and continuously presenting fresh and attractive advertisements. As a specific application field, the system is applied to a campaign management system that automatically generates direct mails emphasizing individual appeal points to millions of customers at the time of a new product announcement.

Regarding optimization of a distribution channel and a distribution timing of an advertisement, the generative AI learns a usage tendency and a past reaction for each customer, and automatically selects an optimal channel and distribution timing from among an SNS, an e-mail, a push notification, a web advertisement, an in-app advertisement, and the like. For example, if an active time on an SNS is at night, an SNS advertisement is distributed at night, and for a customer with a high e-mail open rate, an e-mail advertisement is transmitted in the morning. Specific examples of a prompt sentence to be read by the generative AI include “Propose an optimal distribution channel and distribution timing from a behavior history and a past advertisement reaction of this customer”, “Compare effects of a plurality of distribution channels, and select a channel from which the highest click rate can be expected”, and the like. Specifically, the advertisement generation and distribution unit predicts an optimal distribution timing using a hazard model combining survival time analysis and deep learning. The hazard model models a probability that a customer reacts to an advertisement in a specific time zone over time. Input data to the hazard model is a feature matrix including a past reaction history by channel of the customer, a behavior log indicating a life rhythm, and current context information. For example, the input data is a 128-dimensional tensor including a distribution of past e-mail open times, an elapsed time from the latest application start, and a one-hot vector indicating a current day of the week. The hazard model non-linearly learns an influence of a covariate on a baseline hazard function using a multilayer perceptron. An output of the hazard model is survival curve data indicating a reaction probability at each future time step in each channel. For example, output data is a time-series probability array indicating that a probability of opening a push notification within the next two hours is 0.78. The advertisement generation and distribution unit inputs this output result to an optimization solver, and calculates a distribution schedule that maximizes an overall expected reaction rate while satisfying constraint conditions. With this configuration, the system pinpoints a moment when a customer is most receptive to information, and delivers a message. As a result, the system exhibits a technical effect of minimizing a risk of ignoring an advertisement or opting out, and dramatically improving an engagement rate. As a specific application field, the system is applied to automatic optimization of cross-channel promotion of diverse value-added services provided by a communication carrier.

The performance monitoring and feedback unit automatically aggregates performance indicators such as the number of impressions, the number of clicks, a click rate, the number of conversions, a conversion rate, a stay time, a bounce rate, a unit purchase price, a repeat rate, and sales via an advertisement after advertisement distribution in real time, and the generative AI analyzes these performance data, and automatically and continuously optimizes a selection logic of an advertisement content, a distribution timing, and a distribution channel. For example, when the click rate is low, the advertisement creative is changed, the distribution time zone is adjusted, or discount campaign information is added. Specific examples of a prompt sentence to be read by the generative AI include “Analyze advertisement distribution data and performance indicators for the past 30 days, and propose an advertisement creative and a distribution strategy for maximizing a click rate and a conversion rate”, “Select the most effective advertisement pattern based on A/B test results of a plurality of advertisement patterns, and reflect it in the next distribution”, and the like. Specifically, the performance monitoring and feedback unit processes tens of thousands of event logs per second in real time using a distributed stream processing framework. The performance monitoring and feedback unit optimizes a trade-off between exploration and exploitation using Thompson sampling, which is a kind of multi-armed bandit algorithm. Input data to the multi-armed bandit algorithm is reward history data including the past number of impressions and number of clicks of each advertisement pattern. For example, the input data is a pair of numerical values of 10,000 impressions and 500 clicks for pattern A, and 8,000 impressions and 450 clicks for pattern B. The multi-armed bandit algorithm updates a posterior probability distribution of a true click rate of each pattern as a beta distribution using Bayesian inference. An output of the multi-armed bandit algorithm is an index value indicating an optimal advertisement pattern to be distributed next. For example, output data is an integer value indicating that pattern B is selected based on a sampling result from the posterior distribution. The performance monitoring and feedback unit immediately reflects this output result in a routing table of an advertisement distribution server. With this configuration, the system dynamically shifts traffic to the most effective creative in real time without waiting for the end of a test period unlike a conventional static A/B test. As a result, the system exhibits a technical effect of minimizing opportunity loss and dramatically improving a return on investment of the entire campaign. As a specific application field, the system is applied to a dynamic advertisement operation platform for a flash sale or a limited-time campaign that needs to maximize results in a short period of time.

In this way, by using the system of the present invention, diverse behavior data of a customer is integrated and analyzed in real time, an advertisement content and a distribution strategy optimized for each customer are realized through automatic learning and optimization by the generative AI, and a significant improvement in an advertisement effect and a conversion rate can be achieved. Specifically, the system adopts a hybrid architecture in which edge computing and cloud computing cooperate. The system executes a lightweight inference model on the terminal side to perform real-time behavior analysis, and executes a large-scale generative artificial intelligence model on the server side to perform complex profiling and content generation. Input data to the generative artificial intelligence model on the server side is a compressed feature vector and context information transmitted from an edge device. For example, the input data is a 64-dimensional vector indicating a current emotional state of a user extracted on the terminal side, and a hash value of location information. The generative artificial intelligence model integrates these inputs and executes a global optimization calculation. An output of the generative artificial intelligence model is a control command defining the next action to be executed on the terminal side and generated content data. For example, output data is a structured payload including a rendering instruction of a user interface for displaying a specific discount coupon. The system push-distributes this output result to the terminal through secure WebSocket communication. With this configuration, the system maximizes the use of powerful computing resources of the cloud while suppressing consumption of network bandwidth. As a result, the system exhibits a technical effect of providing a highly personalized experience with low latency in milliseconds even to millions of simultaneously connected users. As a specific application field, the system is applied to a real-time personalization engine in a giant electronic commerce platform deployed globally.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention)

Embodiments for carrying out the present invention will be described more specifically and in detail. The personalized sales promotion system for a physical store of the present invention is composed of a server and a terminal (a customer's smartphone, a tablet, a staff terminal, an in-store signage, an electronic shelf label, a POS terminal, etc.), and is configured such that a data collection unit, a data integration unit, a data analysis unit, a sales promotion generation and distribution unit, and a performance monitoring and feedback unit are provided on the server side, and a data collection auxiliary function, a sales promotion information display function, a user interface function, and a staff support function are provided on the terminal side. Specifically, the personalized sales promotion system for a physical store is constructed as a cyber-physical system integrating an Internet of Things device group and a cloud server. The system includes an edge gateway that collects time-series spatial data from a large number of sensor nodes arranged in a store. The edge gateway establishes a constant connection with the data collection unit on the server side using a Message Queuing Telemetry Transport protocol. Input data to the data collection unit is telemetry data in a binary format transmitted from each sensor node. For example, the input data is a 16-byte data packet including a media access control address of a beacon, a received signal strength indicator, and a time stamp. The data collection unit analyzes this input data and converts it into coordinate data in a three-dimensional space. An output of the data collection unit is a time-series coordinate array indicating a movement route of a customer in the store. For example, output data is structured trajectory data including XYZ coordinates and a stay time. The system stores this output result in a spatial database to prepare for processing in the subsequent data analysis unit. With this configuration, the system maps minute movements of a customer in a physical space as digital data with high accuracy. As a result, the system exhibits a technical effect of visualizing offline customer behavior with a resolution equivalent to that of an online space and making it analyzable. As a specific application field, the system is applied to a customer movement route analysis and real-time store operation support system in a large shopping mall or a department store.

The data collection unit has a function of automatically collecting diverse behavior and attribute data of a customer who visits a physical store in real time. For example, using a beacon, a camera, an infrared sensor, and an RFID reader installed at a store entrance or each sales floor, customer store visit detection, a store entry time, an in-store movement route, a stay time at each sales floor, a stop time in front of a specific shelf, a frequency of multiple store visits, presence or absence of an accompanying person, a congestion status, age group and sex estimation of the customer, and the like are acquired. For example, detailed behavior data is acquired, such as when a customer stays in a home appliance corner for a long time and passes through a clothing corner in a short time, when a customer stops multiple times in a food corner, or when a customer visits the store multiple times in the same time zone. Furthermore, in the case of a customer using a member application, a detailed usage history such as which sales floor the customer stayed in for how many minutes, which shelf the customer stopped in front of, which product the customer searched for in the application, which coupon the customer browsed or used, which push notification the customer opened, which recommended product the customer clicked, a review posting, a questionnaire answer, and a point usage history in the application is collected by location information of the application, Bluetooth linkage, and NFC tag reading. For example, when a customer searches for “refrigerator” in the application, stays in the home appliance corner for a long time, and stops in front of a refrigerator, it can be estimated that a purchasing motivation for a refrigerator is high. In addition, a past purchase history (e.g., purchased products such as a refrigerator, a T-shirt, food, and daily necessities, a purchase date and time, a purchase amount, a purchase frequency, a return history, a point usage history, a gift usage history, a payment method, a purchase channel, and receipt information) is acquired by linkage with a POS system or a member card. For example, when a customer purchases cosmetics of a specific brand every month, it can be determined that brand loyalty is high. Furthermore, through an SNS linkage function, posts such as “new life”, “summer sale”, and “home appliance review” by the customer, a “liked” category, a followed brand, recent comment contents, a store check-in history, a coupon usage history via an SNS, a friend relationship on an SNS, an event participation history, and the like are also collected. For example, when a customer makes posts such as “preparation for new life” and “home appliance review” on an SNS, follows a home appliance brand, and “likes” a campaign post of the store, the information is also to be collected. Specifically, the data collection unit includes an image analysis module using a computer vision technology. The image analysis module extracts attributes and behaviors of a customer from a camera image in the store using a convolutional neural network. Input data to the convolutional neural network is a tensor of a high-resolution moving image frame acquired from a camera. For example, the input data is a four-dimensional tensor in which a three-channel RGB image of 1080 pixels by 1920 pixels is composed of 30 frames per second. The convolutional neural network extracts a spatial feature map from the image through a plurality of convolutional layers and pooling layers. An output of the convolutional neural network is vector data indicating bounding box coordinates of a detected person, an estimated age group, sex, and a line-of-sight direction with respect to a specific shelf. For example, output data is structured metadata indicating that a woman in her thirties is gazing at a specific cosmetics shelf for five seconds. The data collection unit integrates this output result by time-synchronizing it with location information acquired from a beacon and a usage log of an application. With this configuration, the system precisely captures behaviors of a customer who does not have a smartphone or a customer who has not started an application in an anonymized state. As a result, the system exhibits a technical effect of comprehensively and quantitatively grasping traffic of the entire store and a degree of interest of a customer. As a specific application field, the system is applied to optimization of shelf allocation and a real-time inventory replenishment alert system in a supermarket or a drugstore.

The data integration unit identifies these diverse data using a customer ID, a member number, an e-mail address, a terminal identifier, an application ID, location information, an SNS account ID, an RFID tag ID, a receipt number, and the like, and centrally manages them as behavior and attribute data of the same person. For example, even when the same customer uses an application and a member card together, or when a plurality of terminals are used, all data are integrated, duplication and noise are removed, and if there is a missing value, complementation estimation by the generative AI is performed. For example, when a purchase date and time is missing in a part of a purchase history, it is estimated and complemented from other behavior data and patterns of similar customers. Regarding differences in data formats, date notations, currency units, and notational fluctuations of category names (e.g., smartphone, smart phone, etc.) are automatically unified. Regarding duplicate data, when the same purchase history or browsing history is acquired from a plurality of sources, time stamps and contents are compared to eliminate duplication. As a noise removal process, abnormally expensive purchase data, a non-existent product ID, an abnormal access frequency (access by a bot, etc.), an unnatural movement route, a behavior record at a plurality of stores at the same time, and the like are detected, and excluded or corrected. Specifically, the data integration unit implements a hybrid identification engine combining fuzzy logic and machine learning. The data integration unit utilizes a probabilistic graphical model for linking an online customer identifier and an offline physical identifier. Input data to the probabilistic graphical model is a heterogeneous event stream including a background location information log of an application, a connection log of a wireless LAN access point of a store, and a presentation history of a point card. For example, the input data is a history of GPS coordinates linked to a specific customer ID and a connection time stamp of a MAC address detected in the store. The probabilistic graphical model infers a probability of a potential same person from observed events using a hidden Markov model. An output of the probabilistic graphical model is a matrix indicating a joint probability between different identifiers. For example, output data is numerical data indicating that a probability that a specific smartphone terminal and a specific member ID belong to the same person is 0.95. When this probability exceeds a threshold value, the data integration unit merges both data into one integrated customer profile. Furthermore, the data integration unit detects an unnatural movement route and abnormal purchase data using an isolation forest algorithm, and excludes them as outliers. With this configuration, the system realizes seamless customer tracking across a boundary between online and offline. As a result, the system exhibits a technical effect of accurately grasping an overall picture of a customer in an omnichannel environment and preventing an erroneous marketing measure due to fragmented data. As a specific application field, the system is applied to an integrated customer relationship management system in an apparel brand having both a physical store and an electronic commerce site.

The data analysis unit analyzes the integrated customer data set from multiple angles using the generative AI, and extracts interests, purchasing tendencies, store visit patterns, sales floor stay tendencies, application usage tendencies, SNS transmission contents, brand preferences, price sensitivity, purchase cycles, seasonal variations, event participation tendencies, family structure estimation, life stage estimation, purchase budgets, purchase channel preferences, and the like for each customer. For example, it is determined that a customer who has stayed in a home appliance corner for a long time and purchased a refrigerator or a cooking appliance in the past three months has a high interest in home appliances. When there are many posts such as “preparation for a new life” and “home appliance review” on an SNS, it is estimated that a new life demand or a home appliance replacement demand is high. When a coupon is frequently used in an application and new product information of a specific brand is often browsed, it is determined that loyalty to the brand is high. For example, when a customer visits a store in the evening on a weekday, stays in a food corner for a long time, and often purchases health-oriented products, a health-oriented dinner proposal or a recommendation of a recipe video becomes effective. Furthermore, a family structure and a life stage (single, family, senior, student, etc.) are estimated from a purchase history and SNS posts, and for example, a bulk buying campaign and event information for children can be optimized for a family segment, and guidance on health foods and life support services can be optimized for a senior segment. Specifically, the data analysis unit models a complex relationship among a customer, a product, and a location in a store using a graph convolutional network. The data analysis unit constructs a heterogeneous information network in which a customer, a product category, and a specific sales floor area in a store are nodes, and a purchasing behavior and a stay history are edges. Input data to the graph convolutional network is an adjacency matrix of the heterogeneous information network and a feature amount matrix of each node. For example, the input data is a multidimensional tensor including a past purchase amount vector of a customer, a price range vector of a product, and a stay time vector of a sales floor. The graph convolutional network aggregates feature amounts between adjacent nodes and learns a latent representation vector of each node. An output of the graph convolutional network is a link prediction score between a customer node and an unpurchased product node or an unvisited sales floor node. For example, the output data is a prediction score indicating that a probability that a specific customer will next visit an organic food corner and purchase a specific product is 0.88. The data analysis unit generates a profile tag classifying a store visit purpose and a potential need for each customer based on the output result. With this configuration, the system discovers a hidden correlation between a spatial movement pattern and a purchasing behavior, which tends to be overlooked by simple aggregation of purchase histories. As a result, the system exhibits a technical effect of providing a highly accurate recommendation platform for intentionally creating an accidental discovery unique to a physical store. As a specific application field, the system is applied to an in-store navigation and cross-selling proposal system for a customer in a home center having a vast sales floor area.

The sales promotion generation and distribution unit automatically generates an optimal sales promotion content and in-store experience for each customer by the generative AI based on these analysis results. For example, when a customer having a high interest in home appliances is staying in a home appliance corner, “issuing a 10% off coupon for all refrigerators limited to today”, “guiding an experience event of a new life support set”, “displaying a comparison table and recommended points of the latest models on a signage”, “notifying an application of a double point campaign for purchasing a home appliance”, and the like are automatically generated. When a customer having a high interest in fashion is in a clothing corner, “guiding a fitting experience event of a new summer item”, “distributing a discount coupon limited to members to an application”, “guiding an additional point campaign by an SNS post”, “displaying a personal styling proposal by a staff member on a terminal”, and the like are generated. To a customer staying in a food corner for a long time, “guiding a tasting campaign of seasonal fruits”, “displaying a recipe video of a health-oriented product feature on a signage”, “automatically generating a shopping list linked with a recipe proposal in an application”, “issuing a bulk buying discount coupon”, and the like are provided. For example, when a customer activates an application at a store entrance, a “store visit point grant coupon limited to today” is immediately issued, a “10% off coupon for a refrigerator” is push-notified at a timing of approaching a home appliance corner, and a “recommendation of a new life support set” is simultaneously displayed on a signage. Customer service instructions such as “since this customer is highly likely to be considering replacing a refrigerator, prioritize and guide an explanation of the latest model” and “a customer desiring fitting is visiting a fashion corner, implement a personal styling proposal” are automatically transmitted to a staff terminal. It is also possible to display an individual price, recommended product information, and limited campaign information on an electronic shelf label according to a customer attribute. Specifically, the sales promotion generation and distribution unit operates by integrating a reinforcement learning-based dynamic pricing and content generation engine. The sales promotion generation and distribution unit receives a latent representation vector of a customer and current in-store location information output from the data analysis unit as a state space. Input data to the reinforcement learning engine is a state vector including a current location of a customer, a stay time, past price sensitivity, and a current inventory status of a store. For example, the input data is a 128-dimensional numerical vector indicating that a customer has stayed in a meat corner for three minutes, a past discount coupon usage rate is 80%, and an inventory of a specific high-class Wagyu beef is excessive. The reinforcement learning engine calculates at which timing and with what discount rate a coupon should be issued to maximize a profit most using a Q-learning algorithm. An output of the reinforcement learning engine is an action vector defining an optimal sales promotion action. For example, the output data is an identifier indicating an action of immediately push-notifying a 20% discount coupon for high-class Wagyu beef. The sales promotion generation and distribution unit receives this output result, generates a personalized notification text using a large language model, and transmits it to a smartphone terminal of a customer. At the same time, the sales promotion generation and distribution unit transmits a control signal instructing to call out to the corresponding customer to a wearable terminal of a store staff member. With this configuration, the system executes an optimal intervention fusing digital and human touches without missing a moment when a customer's willingness to buy is highest. As a result, the system exhibits a technical effect of dramatically improving a conversion rate in a physical store and contributing to reduction of food loss and excessive inventory. As a specific application field, the system is applied to a real-time inventory-linked personalized promotion system in a large supermarket handling fresh foods.

The performance monitoring and feedback unit automatically aggregates performance indicators such as a coupon usage rate, the number of signage views, a push notification open rate, a product purchase rate, a stay time change, a purchase rate after staff customer service, an SNS post increase rate, a receipt unit price, a repeat store visit rate, an event participation rate, and a questionnaire response rate after sales promotion distribution in real time, and the generative AI analyzes these performance data, and automatically and continuously optimizes a selection logic of a sales promotion content, a distribution timing, a distribution channel, and a customer service instruction. For example, a sales promotion measure can be dynamically improved, such as changing a discount rate or a target product when a coupon usage rate is low, adjusting a display position or a content when the number of signage views is small, or deploying a customer service pattern to other staff members when a purchase rate after staff customer service is high. Furthermore, an A/B test or a multivariate test is automatically executed to select a sales promotion pattern having the highest effect. For example, a plurality of sales promotions using different catchphrases or images for the same product are distributed, and which pattern shows the highest coupon usage rate or purchase rate is automatically determined. Specifically, the performance monitoring and feedback unit matches an online sales promotion distribution log and an offline POS register passage log in real time using a complex event processing engine. The performance monitoring and feedback unit calculates a pure incremental effect given to an actual purchasing behavior by a distributed sales promotion measure using a causal inference model. Input data to the causal inference model is a data set including a binary variable indicating presence or absence of intervention of a sales promotion measure, an attribute vector of a customer, and an objective variable indicating a purchase result. For example, the input data is a multidimensional matrix including a purchase amount and a store visit frequency of a customer group that has received a specific coupon and a control group that has not received it. The causal inference model estimates a treatment effect at an individual customer level using a meta-learner. An output of the causal inference model is an uplift score of a sales promotion measure for each customer. For example, the output data is a predicted value that a purchase probability improves by 15% by distributing a coupon. The performance monitoring and feedback unit automatically updates a parameter of the sales promotion generation and distribution unit based on this output result so as to stop a useless discount for a customer who purchases even without distributing a coupon and narrow down a target to a customer who purchases only with a coupon. With this configuration, the system measures a true return on investment based on a causal relationship rather than a mere correlation, and optimizes a measure. As a result, the system exhibits a technical effect of thoroughly eliminating waste of promotion costs and maximizing a profit margin. As a specific application field, the system is applied to an automatic allocation and optimization system of a company-wide sales promotion budget in a retail chain of small profits and quick returns where management of a profit margin is extremely important.

From a viewpoint of security and privacy protection, customer data is encrypted and transmitted to a server, and access authority management and anonymization processing are executed. For example, personally identifiable information is hashed, and only anonymized data is used for sales promotion distribution and analysis. A function allowing a customer to opt out of data collection and sales promotion distribution according to a privacy setting is also provided on a terminal side. For example, a range of data collection and whether or not to receive a sales promotion notification can be finely controlled from a setting screen of an application. Specifically, the security management unit encrypts data using an advanced encryption algorithm. The processing unit converts personal identification information into a fixed-length hash vector by an irreversible hash function. The system generalizes data so as to satisfy k-anonymity and l-diversity as anonymization processing. When receiving an opt-out request, the system assigns an inaccessible flag to a data record of a corresponding customer. The system generates and stores an encryption key using a hardware security module. The management unit encrypts a communication path between a customer terminal and a server by a transport layer security protocol. The management unit applies an advanced encryption standard algorithm to a data record stored in a database. The management unit applies a secure hash algorithm with a salt to a field including personal information, and converts it into an irreversible hash value. The management unit applies a differential privacy technology when generating a learning data set of a machine learning model. The processing unit adds noise following a Laplace distribution to an original data vector, making it mathematically difficult to identify an individual. The management unit receives an opt-out request from a customer via an application programming interface. The management unit invalidates a data processing flag of a corresponding customer based on the received request. Thereby, a technical effect of reducing a data leakage risk and improving safety of the system is exhibited. As a specific application field, it is applicable to a customer data management system of a medical institution or a financial institution to which strict privacy regulations are applied.

As described above, the embodiment of the present invention is configured with depth from all viewpoints, such as cooperative operation of a server and a terminal, multilayered and continuous utilization of a generative AI, integrated operation of diverse data sources and distribution channels such as a beacon, a camera, a sensor, a POS, an application, and an SNS, real-time data processing and sales promotion optimization, automatic improvement by an A/B test and a multivariate test, and thorough security and privacy protection, and realizes an unprecedented highly accurate and highly efficient personalized sales promotion experience. Specifically, the system adopts a distributed processing architecture in which a plurality of hardware components and software modules are tightly coupled. The system executes asynchronous communication between an edge device and a cloud server. The system integrates a plurality of machine learning models including a large language model and a convolutional neural network by ensemble learning. The system executes inference in units of milliseconds using a real-time data stream processing platform. The system uses a result of a multivariate test as a reward signal of a reinforcement learning model. The reinforcement learning model selects an optimal sales promotion action based on a Markov decision process. The system maps heterogeneous data collected from each data source to a common multidimensional tensor space. The system executes a vector operation on this tensor space, and extracts a potential preference of a customer. The system inputs the extracted preference vector to a generative artificial intelligence model. The model outputs a parameter of an optimal sales promotion content from the preference vector. The system dynamically renders a content based on the output parameter. Thereby, a technical effect of minimizing a processing delay of the entire system and dramatically improving personalization accuracy is exhibited. As a specific application field, it is applicable to an integrated marketing system in a large-scale commercial complex or a retail chain expanding nationwide.

### System Configuration

The system according to the present embodiment comprises a data collection unit, a data integration unit, a data analysis unit, a sales promotion generation and distribution unit, a performance monitoring and feedback unit, a security and privacy management unit, and a user interface unit. The data collection unit has a function of automatically collecting diverse behavior and attribute data of a customer who has visited a physical store in real time, and can acquire, for example, customer store visit detection, a store entry time, an in-store movement route, a stay time in each sales floor, a stop time in front of a specific shelf, a frequency of multiple store visits, presence or absence of an accompanying person, a congestion status, and age group and gender estimation of a customer using a beacon, a camera, an infrared sensor, and an RFID reader installed at a store entrance or each sales floor. Furthermore, in the case of a customer using a member application, a detailed usage history such as which sales floor the customer stayed in for how many minutes, which shelf the customer stopped in front of, which product the customer searched for in the application, which coupon the customer browsed or used, which push notification the customer opened, which recommended product the customer clicked, a review post in the application, a questionnaire response, and a point usage history can be collected by location information of the application, Bluetooth linkage, and NFC tag reading. Furthermore, a past purchase history, a purchase date and time, a purchase amount, a purchase frequency, a return history, a point usage history, a gift usage history, a payment method, a purchase channel, receipt information, and the like can be acquired by POS system or member card linkage. Furthermore, through an SNS linkage function, categories in which a customer posted or “liked” such as “new life”, “summer sale”, and “home appliance review”, followed brands, recent comment contents, a store check-in history, a coupon usage history via an SNS, a friend relationship on an SNS, an event participation history, and the like can also be collected. Specifically, the data collection unit continuously receives time-series data from a plurality of sensor nodes arranged in a store. The data collection unit converts a received analog signal into digital data. The data collection unit converts image data acquired from a camera into a three-dimensional image tensor. The data collection unit inputs the image tensor to a pre-learned object detection neural network. The neural network outputs bounding box coordinates and a feature vector of a customer from the image tensor. The data collection unit calculates two-dimensional coordinates of a customer by a trilateration algorithm using a radio wave intensity indicator received from a beacon. The data collection unit combines these spatial coordinate data and a time stamp to generate time-series array data indicating a movement trajectory of a customer. The data collection unit stores purchase data acquired from a point-of-sale information management system in a database as a structured transaction record. The data collection unit generates a word embedding vector from text data of social media using a natural language processing model. The data collection unit analyzes a signal intensity of a near field communication standard, and estimates a physical distance between a customer and a specific product in units of millimeters. The data collection unit publishes these multidimensional data to a real-time message queue. Thereby, a technical effect of highly accurately digitizing behavior data in a physical space and a virtual space and improving calculation efficiency of subsequent analysis processing is exhibited. As a specific application field, it is applicable to a customer behavior tracking system in a smart store or an unmanned checkout store.

The data integration unit has a function of identifying the diverse data obtained from the data collection unit using a customer ID, a member number, an e-mail address, a terminal identifier, an application ID, location information, an SNS account ID, an RFID tag ID, a receipt number, and the like, and centrally managing them as behavior and attribute data of the same person. For example, even when the same customer uses an application and a member card together or uses a plurality of terminals, all data can be integrated, duplication and noise can be removed, and if there is a missing value, complementation estimation by the generative AI can be performed. Regarding a difference in data format, date notation, a currency unit, and notation fluctuation of a category name can be automatically unified, and regarding duplicate data, when the same purchase history or browsing history is acquired from a plurality of sources, duplication can be eliminated by comparing time stamps and contents. As noise removal processing, abnormally expensive purchase data, a non-existent product ID, an abnormal access frequency, an unnatural movement route, behavior records in a plurality of stores at the same time, and the like can be detected and excluded or corrected. Specifically, the data integration unit converts data of heterogeneous formats into a multidimensional tensor having a common schema. The data integration unit constructs graph structure data in which an identifier extracted from each data source is a node and a co-occurrence relationship is an edge in identification processing. The data integration unit clusters a node group belonging to the same person using a graph neural network. The data integration unit merges a plurality of records into a single integrated profile vector based on a clustering result. The data integration unit uses an autoencoder-based generative model for missing value complementation. The generative model receives an incomplete profile vector as an input. The generative model outputs a complete profile vector in which a missing element is complemented via feature representation in a latent space. The data integration unit executes a statistical outlier detection algorithm for noise removal. The processing unit calculates a Mahalanobis distance, and excludes a data point exceeding a predetermined threshold as an abnormal value. The data integration unit embeds text data of a category name or a product name in a vector space using a natural language processing technology. The data integration unit maps a character string with notation fluctuation to standardized master data by calculating a cosine similarity. The data integration unit performs normalization to an absolute time based on a network time protocol in order to resolve inconsistency of time stamps. Thereby, a technical effect of ensuring quality and consistency of data and improving inference accuracy of a subsequent machine learning model is exhibited. As a specific application field, it is applicable to a customer data platform system of a retail business performing omnichannel deployment.

The data analysis unit has a function of analyzing the integrated customer data set from multiple angles using the generative AI, and extracting interests, purchasing tendencies, store visit patterns, sales floor stay tendencies, application usage tendencies, SNS transmission contents, brand preferences, price sensitivity, purchase cycles, seasonal variations, event participation tendencies, family structure estimation, life stage estimation, purchase budgets, purchase channel preferences, and the like for each customer. For example, it is determined that a customer who has stayed in a home appliance corner for a long time and purchased a refrigerator or a cooking appliance has a high interest in home appliances, when there are many posts such as “preparation for a new life” and “home appliance review” on an SNS, it is estimated that a new life demand or a home appliance replacement demand is high, when a coupon is frequently used in an application and new product information of a specific brand is often browsed, it is determined that loyalty to the brand is high, and when a customer visits a store in the evening on a weekday, stays in a food corner for a long time, and often purchases health-oriented products, a health-oriented dinner proposal or a recommendation of a recipe video becomes effective. Furthermore, a family structure and a life stage (single, family, senior, student, etc.) are estimated from a purchase history and SNS posts, and a bulk buying campaign and event information for children can be optimized for a family segment, and guidance on health foods and life support services can be optimized for a senior segment. Specifically, the data analysis unit inputs an integrated profile vector to a large language model and a deep learning model. The data analysis unit inputs time-series purchase history data to a recurrent neural network. The recurrent neural network updates a hidden state vector of a past purchase pattern, and outputs a next purchase probability distribution. The data analysis unit adopts a transformer architecture as a natural language processing model. The model tokenizes text data of social media, and analyzes a context using a self-attention mechanism. The model outputs a multidimensional feature vector including an interest score and an emotion polarity value from the input text data. For example, the model receives an embedding vector of a text indicating that a refrigerator is being searched for toward a new life as an input. The model outputs structured data of a home appliance category interest degree of 0.95 and a new life demand flag of 1 as an output. The data analysis unit compares these output scores with a predetermined threshold. The data analysis unit assigns an attribute label exceeding the threshold to a customer profile. The data analysis unit inputs a time-series array of location information to a convolutional neural network, and extracts a feature map of a stay pattern. The data analysis unit calculates an attachment degree score to a specific sales floor from the extracted feature map. Thereby, a technical effect of realizing objective and high-dimensional feature extraction not relying on human intuition and dramatically improving personalization accuracy is exhibited. As a specific application field, it is applicable to a customer relationship management system or an advanced recommendation engine.

The sales promotion generation and distribution unit has a function of automatically generating an optimal sales promotion content and in-store experience for each customer by the generative AI based on these analysis results, and distributing them in real time through a plurality of channels such as an in-store signage, an electronic shelf label, an application notification, a push notification, a staff terminal, receipt printing, and e-mail distribution. For example, when a customer having a high interest in home appliances is staying in a home appliance corner, “issuing a 10% off coupon for all refrigerators limited to today”, “guiding an experience event of a new life support set”, “displaying a comparison table and recommended points of the latest models on a signage”, “notifying an application of a double point campaign for purchasing a home appliance”, and the like are automatically generated, when a customer having a high interest in fashion is in a clothing corner, “guiding a fitting experience event of a new summer item”, “distributing a discount coupon limited to members to an application”, “guiding an additional point campaign by an SNS post”, “displaying a personal styling proposal by a staff member on a terminal”, and the like are generated, and to a customer staying in a food corner for a long time, “guiding a tasting campaign of seasonal fruits”, “displaying a recipe video of a health-oriented product feature on a signage”, “automatically generating a shopping list linked with a recipe proposal in an application”, “issuing a bulk buying discount coupon”, and the like are provided. Furthermore, customer service instructions such as “since this customer is highly likely to be considering replacing a refrigerator, prioritize and guide an explanation of the latest model” and “a customer desiring fitting is visiting a fashion corner, implement a personal styling proposal” are automatically transmitted to a staff terminal, and an individual price, recommended product information, and limited campaign information can be displayed on an electronic shelf label according to a customer attribute. Specifically, the sales promotion generation and distribution unit inputs an extracted feature vector of a customer and an inventory data vector of a store to a generative artificial intelligence model. The generative artificial intelligence model is configured using a conditional generative adversarial network or a large language model. The model outputs an optimal sales promotion text, image data, and a parameter of a distribution timing based on the input feature vector. For example, the model receives a state vector of a home appliance interest degree of 0.95 and a current location of a home appliance corner as an input. The model outputs a text character string of 10% off for a refrigerator and an image tensor for signage display as an output. The sales promotion generation and distribution unit resizes the output image tensor according to a resolution of a digital signage in a store. The sales promotion generation and distribution unit transmits the generated sales promotion data to a target terminal with low latency using an optimized routing algorithm. The sales promotion generation and distribution unit transmits structured data including a priority score of customer service and a recommended talk script to a staff terminal as a push notification. The sales promotion generation and distribution unit transmits bitmap data of price information and a promotion image to an electronic shelf label using a low power consumption wireless communication protocol. Thereby, information provision completely synchronized with a real-time situation of a customer becomes possible, and a technical effect of dramatically improving a purchase conversion rate is exhibited. As a specific application field, it is applicable to a real-time marketing automation system or a smart signage control system.

The performance monitoring and feedback unit has a function of automatically aggregating performance indicators such as a coupon usage rate, the number of signage views, a push notification open rate, a product purchase rate, a stay time change, a purchase rate after staff customer service, an SNS post increase rate, a receipt unit price, a repeat store visit rate, an event participation rate, and a questionnaire response rate after sales promotion distribution in real time, analyzing these performance data by the generative AI, and automatically and continuously optimizing a selection logic of a sales promotion content, a distribution timing, a distribution channel, and a customer service instruction. For example, it is possible to dynamically improve sales promotion measures, such as changing a discount rate or a target product when the coupon usage rate is low, adjusting a display position or a content when the number of signage views is small, or deploying a customer service pattern to other staff when the purchase rate after staff customer service is high. Furthermore, it is possible to automatically execute an A/B test or a multivariate test, and select a sales promotion pattern with the highest effect. Specifically, the performance monitoring and feedback unit stream-processes an event log asynchronously transmitted from each distribution channel by a real-time processing engine. The processing unit calculates evaluation indicators such as a click rate and a purchase conversion rate from the event log as a numerical vector. The processing unit inputs the calculated numerical vector to a reward function of a reinforcement learning model. The reinforcement learning model updates a selection probability of a sales promotion action using a policy gradient method or a Q-learning algorithm. The processing unit generates a combination of a plurality of sales promotion parameters based on an orthogonal array in execution of the multivariate test. The processing unit inputs a performance score for each combination to a Bayesian optimization algorithm. The algorithm searches for and outputs a next sales promotion parameter that maximizes an acquisition function. The system sets the output parameter as an initial value of a next sales promotion generation process. The processing unit inputs reaction data to a Bayesian estimation model using a Markov chain Monte Carlo method. The model sequentially updates a posterior probability distribution of a true conversion rate of each sales promotion measure. The system dynamically selects a next optimal sales promotion measure from the posterior probability distribution using a Thompson sampling algorithm. Thereby, there is a technical effect that the system autonomously repeats learning and continuously maximizes a sales promotion effect without human intervention. As specific application fields, it is applicable to an autonomous digital marketing platform and a dynamic pricing system.

A security and privacy management unit is responsible for encryption of customer data, access authority management, anonymization processing, privacy setting management, and the like, and realizes an operation conforming to a personal information protection law and various regulations. For example, personally identifiable information is hashed, only anonymized data is used for sales promotion distribution and analysis, and a function allowing a customer to opt out of data collection and sales promotion distribution is also provided on the terminal side. Specifically, the security and privacy management unit generates and stores an encryption key using a hardware security module. The management unit encrypts a communication path between a customer terminal and a server by a transport layer security protocol. The management unit applies an advanced encryption standard algorithm to a data record stored in a database. The management unit applies a secure hash algorithm with salt to a field including personal information to convert it into an irreversible hash value. The management unit applies a differential privacy technology when generating a learning data set of a machine learning model. The processing unit adds noise following a Laplace distribution to an original data vector to make it mathematically difficult to identify an individual. The management unit receives an opt-out request from a customer via an application programming interface. The management unit invalidates a data processing flag of the corresponding customer based on the received request. The management unit records an access log in a blockchain-based distributed ledger to prevent falsification. The management unit automatically executes a vulnerability scan periodically and applies a security patch. Thereby, there is a technical effect of enabling safe data utilization while fully complying with data protection regulations. As specific application fields, it is applicable to an electronic commerce platform expanding globally and a financial service with strict personal information protection.

A user interface unit provides an intuitive screen and operation means for a customer to browse sales promotion information, use a coupon, answer a questionnaire, and post a review, and for a staff member to confirm a customer service instruction and monitor an effect of a sales promotion measure on a customer's smartphone or tablet, a staff terminal, a signage, an electronic shelf label, or the like. Specifically, the user interface unit is constructed using a front-end web application framework. The interface unit receives sales promotion data in a structured data format from a server by asynchronous communication. The interface unit dynamically updates a document object model based on the received data to draw a screen. The interface unit captures an event of a customer's touch operation or scroll operation. The interface unit transmits the captured operation event to the server as log data together with a time stamp. The interface unit superimposes and displays customer attribute information and a recommended action on a camera image using an augmented reality technology on the staff terminal. The interface unit transmits bitmap data of price information and a promotion image to the electronic shelf label using a low power consumption wireless communication protocol. The interface unit visualizes real-time performance indicators as a multidimensional chart on a dashboard for an administrator. The interface unit immediately reflects a state change occurring on the server side on a client screen using WebSocket communication. Thereby, there is a technical effect of reducing a user's cognitive load and realizing intuitive and rapid information transmission. As specific application fields, it is applicable to an employee support application of a next-generation store and an interactive kiosk terminal for a customer.

Specific examples of a prompt sentence to be read by the generative AI when carrying out the present invention include “Propose a product category with the highest interest and an optimal sales promotion content for a customer currently visiting the store based on a store visit history, a purchase history, an application usage history, and an SNS post content of this customer”, “Generate a recommended product and a promotion sentence to be displayed on an in-store signage from a stay area and a past purchasing tendency of a customer”, “Automatically generate a refrigerator comparison table and a discount coupon for a customer staying in a home appliance corner for a long time, and distribute them to an application and a signage”, and “Select the most effective sales promotion pattern based on A/B test results of a plurality of sales promotion patterns, and reflect it in the next distribution”. Specifically, the system dynamically constructs these prompt sentences as an input query to a natural language processing model. The system converts customer attribute data and behavior history data into a structured text format. The system inserts the converted text data into a placeholder of a prompt. The system passes the completed prompt character string to an input layer of a large language model. The large language model sequentially calculates an appearance probability of a next word using a decoder block of a transformer architecture. The model generates an optimal response text based on the calculated probability distribution. For example, the system generates a prompt including a context of a customer identifier 123, a stay area home appliances, and a past purchase history television as an input. The model outputs text data of a recommended product soundbar and a promotion sentence theater acoustics at home as an output. The system parses this output text and passes it to a subsequent distribution module. The system adds a text vector of a past success case as an example of few-shot learning in generation of the prompt. Thereby, there is a technical effect of automatically generating flexible and highly personalized content without programming a complex conditional branch. As specific application fields, it is applicable to an interactive artificial intelligence assistant and an automatic content generation system.

### Implementation Steps

Step 1: Multidimensional Customer Data Collection Behavior and attribute data of a customer who visits a physical store are automatically collected in real time. For example, customer store visit detection, a store entry time, an in-store movement route, a stay time in each sales floor, a stop time in front of a specific shelf, a frequency of multiple store visits, presence or absence of an accompanying person, a congestion status, customer age group/gender estimation, and the like are acquired using a beacon, a camera, an infrared sensor, and an RFID reader installed at a store entrance and each sales floor. Furthermore, a detailed usage history such as which sales floor the customer stayed in and for how many minutes, which product the customer searched for, which coupon the customer browsed/used, which push notification the customer opened, which recommended product the customer clicked, a review post in an application, a questionnaire response, and a point usage history is collected by location information of a member application, Bluetooth linkage, and NFC tag reading. A past purchase history, a purchase date and time, a purchase amount, a purchase frequency, a return history, a point usage history, a gift usage history, a payment method, a purchase channel, receipt information, and the like are acquired by POS system and member card linkage, and a customer's post, a “liked” category, a followed brand, a comment content, a store check-in history, a coupon usage history via an SNS, a friend relationship on an SNS, an event participation history, and the like are also collected through an SNS linkage function. Specifically, in this step, the system executes primary processing of sensor data using an edge computing device. The system temporarily stores a video stream of 30 frames per second acquired from a camera in a memory buffer. The system extracts a frame image from the video stream and inputs it to a lightweight convolutional neural network. The network detects a person region in the image and extracts a feature vector. The system transmits the extracted feature vector to a cloud server to save a communication band. The system periodically receives global positioning system coordinates and time-series data of an acceleration sensor from a smartphone application. The system inputs these multidimensional sensor data to a Kalman filter to estimate accurate location coordinates of the customer while removing noise. The system collates the estimated location coordinates with floor map data of the store to perform a stay determination within a specific sales floor polygon. The system reads a unique identifier of a tag attached to a product by radio waves using a radio frequency identification reader. The system calculates accurate location coordinates of the product by triangulation from the read tag information and a reception intensity of an antenna. Thereby, there is a technical effect of efficiently processing a huge amount of raw data and realizing highly accurate behavior tracking. As specific application fields, it is applicable to a flow line analysis system of a large-scale exhibition hall and a worker tracking system of a smart factory.
Step 2: Data Integration, Identification, and Cleansing The collected diverse data are identified using a customer ID, a member number, an e-mail address, a terminal identifier, an application ID, location information, an SNS account ID, an RFID tag ID, a receipt number, and the like, and are centrally managed as behavior and attribute data of the same person. Differences in data formats (e.g., date notation, currency unit, and notation fluctuation of a category name) are automatically unified, and regarding duplicate data, a time stamp and a content are compared to eliminate duplication. As a noise removal process, abnormally expensive purchase data, a non-existent product ID, an abnormal access frequency, an unnatural movement route, behavior records at a plurality of stores at the same time, and the like are detected and excluded or corrected. If there is a missing value, complementation estimation by the generative AI is performed. Specifically, in this step, the system performs parallel processing of a large-scale data set using a distributed processing framework. The system temporarily stores a record collected from each data source in a key-value store. The system calculates a similarity score of character string data with notation fluctuation using a fuzzy matching algorithm. The system links a record group whose similarity score exceeds a predetermined threshold as the same entity. The system uses a generative adversarial network for missing value complementation. A generator of the network infers a complete data vector from an incomplete data vector. A discriminator of the network discriminates between the inferred data and actual complete data. The system generates extremely natural complementation data by causing both to perform competitive learning. The system executes an isolation forest algorithm for noise removal to specify and delete an abnormal value isolated from other data points in a multidimensional space. The system embeds text data of a category name or a product name in a vector space using a natural language processing technology. The system maps a character string with notation fluctuation to standardized master data by calculating a cosine similarity. Thereby, there is a technical effect of providing high-quality input data to a subsequent machine learning model and improving reliability of inference. As specific application fields, it is applicable to a customer data integration platform and a big data analysis infrastructure.
Step 3: Customer Profiling and Attribute Extraction (Utilization of Generative AI) The integrated customer data set is input to the generative AI, and interests, purchasing tendencies, store visit patterns, stay tendencies for each sales floor, application usage tendencies, SNS transmission contents and brand preferences, price sensitivity, a purchase cycle, seasonal variation, event participation tendencies, family structure estimation, life stage estimation, a purchase budget, purchase channel preferences, and the like for each customer are extracted from multiple angles. For example, a customer who stays in a home appliance corner for a long time and purchases a refrigerator or a cooking appliance is determined to have a high interest in home appliances, when there are many posts such as “preparation for a new life” and “home appliance review” on an SNS, it is estimated that a new life demand or a home appliance replacement demand is high, and when a coupon is frequently used in an application and new product information of a specific brand is often browsed, it is determined that loyalty to the brand is high. Specific examples of a prompt sentence to be read by the generative AI: “Propose a product category with the highest interest and an optimal sales promotion content for a customer currently visiting the store based on a store visit history, a purchase history, an application usage history, and an SNS post content of this customer”, “Generate a recommended product and a promotion sentence to be displayed on an in-store signage from a stay area and a past purchasing tendency of a customer”. Specifically, in this step, the system inputs the integrated customer data set to a deep learning model equipped with a multilayer perceptron and a self-attention mechanism. The model maps the input multidimensional attribute vector and behavior history sequence to a low-dimensional vector in a latent space. The model regression-calculates a purchase probability and an interest score of the customer from the latent vector. For example, the system gives a numerical vector of a total stay time in the home appliance corner of 120 minutes in the past month and an appearance frequency of home appliance-related words on social media of 5 times as an input to the model. The model outputs predicted values of a refrigerator purchase probability of 0.85 and a price sensitivity score of 0.4 as an output. The system writes these predicted values in a customer profile database. The system transmits a structured prompt including these predicted values to a generative artificial intelligence model. The generative artificial intelligence model analyzes a context of the prompt and outputs a text description of an optimal sales promotion strategy. The system inputs time-series data of a purchase history to a long short-term memory network to learn a dependency relationship of a long-term purchase cycle. Thereby, there is a technical effect of extracting a hidden pattern behind a complex customer behavior and enabling precise targeting. As specific application fields, it is applicable to a predictive marketing system and an advanced customer segmentation tool.
Step 4: Personalized Sales Promotion Generation and Distribution (Utilization of Generative AI) The generative AI automatically generates an optimal sales promotion content and in-store experience for each customer based on a customer profile and a behavior tendency, and distributes them in real time through a plurality of channels such as an in-store signage, an electronic shelf label, an application notification, a push notification, a staff terminal, receipt printing, and e-mail distribution. For example, a 10% off coupon for a refrigerator and an experience event guide for a new life support set are automatically generated and distributed to a customer staying in a home appliance corner, a fitting experience event and a limited coupon to a customer staying in a fashion corner, a tasting campaign and a recipe video to a customer staying in a food corner, and a customer service instruction according to a customer attribute to a staff terminal. Specific examples of a prompt sentence to be read by the generative AI: “Automatically generate a refrigerator comparison table and a discount coupon for a customer staying in a home appliance corner for a long time, and distribute them to an application and a signage”, “Display a personal styling proposal on a staff terminal while a customer who desires fitting is visiting a fashion corner”. Specifically, in this step, the system format-converts the sales promotion content output from the generative artificial intelligence model in accordance with specifications of each distribution channel. The system inputs text data to a speech synthesis engine to generate speech waveform data for in-store broadcasting. The system dynamically renders a promotion image with a color scheme tailored to a customer's preference using an image generation model. The system registers the generated content and an identifier of a distribution destination device in a message queuing system. The system push-distributes the content to each device asynchronously and in real time using a publish-subscribe model. For example, the system receives a text of 10% off a refrigerator and a smartphone identifier of a target customer as an input. The system transmits a push notification payload via a push notification service standard in a smartphone operating system as an output. The system immediately reflects structured data of a customer service instruction on a screen using WebSocket communication for the staff terminal. The system transmits bitmap data of price information and a promotion image to the electronic shelf label using a low power consumption wireless communication protocol. Thereby, information transmission at an optimal timing and through an optimal channel is realized, and there is a technical effect of dramatically improving a customer experience. As specific application fields, it is applicable to an omnichannel distribution platform and a real-time customer service support system.
Step 5: Performance Monitoring and Feedback Optimization (Utilization of Generative AI) Performance indicators such as a coupon usage rate, the number of signage views, a push notification open rate, a product purchase rate, a stay time change, a purchase rate after staff customer service, an SNS post increase rate, a receipt unit price, a repeat store visit rate, an event participation rate, and a questionnaire response rate after sales promotion distribution are automatically aggregated in real time, the generative AI analyzes these performance data, and a selection logic of a sales promotion content, a distribution timing, a distribution channel, and a customer service instruction is automatically and continuously optimized. For example, sales promotion measures are dynamically improved, such as changing a discount rate or a target product when the coupon usage rate is low, adjusting a display position or a content when the number of signage views is small, or deploying a customer service pattern to other staff when the purchase rate after staff customer service is high. Specific examples of a prompt sentence to be read by the generative AI: “Select the most effective sales promotion pattern based on A/B test results of a plurality of sales promotion patterns, and reflect it in the next distribution”, “Analyze sales promotion distribution data and performance indicators for the past 30 days, and propose a sales promotion creative and a distribution strategy for maximizing a coupon usage rate and a purchase rate”. Specifically, in this step, the system accumulates an action log returned from each device in a real-time database. The system aggregates the accumulated log data for each certain time window to generate an evaluation indicator tensor such as a conversion rate and a click-through rate. The system inputs this evaluation indicator tensor as an environmental state of a deep reinforcement learning model. The deep reinforcement learning model adopts a deep Q-network architecture. The model calculates a Q-value of an optimal sales promotion action that maximizes a future cumulative reward from a current state vector and a past behavior history. The system selects an action having the highest Q-value as a next distribution strategy. For example, the system receives a result data vector of a usage rate of coupon A of 5% and a usage rate of coupon B of 12% as an input. The model outputs a policy update parameter of raising a distribution ratio of coupon B to 80% next time as an output. The system automatically updates a weight of a distribution logic using this parameter. The system generates a combination of a plurality of sales promotion parameters based on an orthogonal array in execution of a multivariate test. The system inputs a performance score for each combination to a Bayesian optimization algorithm, and searches for a next sales promotion parameter that maximizes an acquisition function. Thereby, there is a technical effect that the system autonomously adapts to changes in a market environment and customer reactions, and maximizes a long-term return on investment. As specific application fields, it is applicable to an autonomous optimization type advertisement distribution server and a dynamic campaign management system.

### Specific Use Case

For example, when the system of the present invention is used in a physical store, behavior data such as a store entry time of a visiting customer, an in-store movement route, a stay time at each sales floor, a stop time in front of a specific shelf, presence or absence of an accompanying person, a congestion status, and age group/gender estimation of the customer can be acquired in real time using a beacon, a camera, an infrared sensor, and an RFID reader installed at a store entrance and each sales floor. Further, when the customer uses a member application, a detailed usage history such as which sales floor the customer stayed at for how many minutes, which product the customer searched for, which coupon the customer browsed/used, which push notification the customer opened, which recommended product the customer clicked, an in-app review post, a questionnaire answer, and a point usage history can be collected by location information of the application, Bluetooth linkage, and NFC tag reading. Further, a past purchase history, a purchase date and time, a purchase amount, a purchase frequency, a return history, a point usage history, a gift usage history, a payment method, a purchase channel, receipt information, and the like of the customer can be acquired by a POS system and member card linkage. Further, through an SNS linkage function, categories in which the customer posted or “liked” such as “new life”, “summer sale”, and “home appliance review”, a followed brand, a recent comment content, a store check-in history, a coupon usage history via an SNS, a friend relationship on the SNS, an event participation history, and the like can also be collected. Specifically, the present system collects sensing data at a high frequency from an Internet of Things device group arranged at various places in the store. The present system counts a pulse signal obtained from the infrared sensor by a microcontroller, and aggregates it as passing number-of-people data. The present system reads a unique identifier of a tag attached to a product by a radio wave using a radio frequency identification reader. The present system calculates an accurate position coordinate of the product by triangulation from the read tag information and a reception intensity of an antenna. The present system establishes communication in the background with a dedicated application installed in a smartphone of the customer. The present system specifies an indoor position of the customer with a positioning accuracy in units of several centimeters using a beacon signal of a short-range wireless communication standard. The present system filters and compresses raw data acquired from these pieces of hardware in an edge gateway. The present system transfers the compressed data packet to a data lake on a cloud via a secure virtual private network. The present system converts image data acquired from the camera into a three-dimensional image tensor, and inputs it to a pre-trained object detection neural network. Thereby, there is a technical effect of collecting enormous and diverse physical space data without loss while suppressing consumption of a network bandwidth. As a specific application field, it is applicable to a behavior analysis platform of a next-generation supermarket or a large-scale shopping mall.

These diverse data are subjected to identification processing using a customer ID, a member number, an e-mail address, a terminal identifier, an application ID, location information, an SNS account ID, an RFID tag ID, a receipt number, and the like, and are centrally managed as behavior and attribute data of the same person. Differences in data formats (e.g., date notation, currency unit, and orthographical variants of category names) are automatically unified, and duplicate data is deduplicated by comparing timestamps and contents. As a noise removal process, abnormally expensive purchase data, a non-existent product ID, an abnormal access frequency, an unnatural movement route, behavior records in a plurality of stores at the same time, and the like are detected, excluded, or corrected. If there is a missing value, complementation and estimation by the generative AI are performed. Specifically, the present system inputs unstructured data and semi-structured data accumulated in the data lake into an extract, transform, load processing pipeline. The present system processes petabyte-class data at high speed in-memory using a distributed processing engine. The present system embeds text data of a category name and a product name into a vector space using a natural language processing technology. The present system maps a character string having an orthographical variant to standardized master data by calculating a cosine similarity. The present system performs normalization to an absolute time based on a network time protocol in order to resolve an inconsistency of timestamps. The present system applies an unsupervised learning model using an autoencoder for anomaly detection. This model learns a reconstruction error of a normal data pattern. The present system automatically excludes a data record whose reconstruction error exceeds a preset threshold value as noise. For a missing value, the present system complements it with an average value of other customer data most similar on a feature space using a k-nearest neighbor algorithm. The present system clusters a node group belonging to the same person using a graph neural network, and merges a plurality of records into a single integrated profile vector. Thereby, there is a technical effect of constructing a clean and high-dimensional integrated data set optimal for learning of a machine learning model. As a specific application field, it is applicable to an integrated customer data platform or an enterprise data warehouse.

The integrated customer data set is analyzed from multiple angles by the generative AI, and interests, purchasing tendencies, store visit patterns, stay tendencies for each sales floor, application usage tendencies, SNS transmission contents, brand preferences, price sensitivities, purchase cycles, seasonal variations, event participation tendencies, family structure estimations, life stage estimations, purchase budgets, purchase channel preferences, and the like for each customer are extracted. For example, a customer who stays in a home appliance corner for a long time and purchases a refrigerator or a cooking appliance is determined to have high interests in home appliances, and when there are many posts such as “preparation for a new life” and “home appliance review” on an SNS, it is estimated that a new life demand or a home appliance replacement demand is high. When the customer frequently uses a coupon in an application and often browses new product information of a specific brand, it is determined that loyalty to the brand is high. A sales promotion content according to an attribute is optimized, such as a bulk buying campaign and event information for children for a family demographic, and guidance on health foods and life support services for a senior demographic. Specifically, the present system inputs the cleansed integrated data set to an ensemble of a plurality of specialized machine learning models. The present system inputs time-series data of a purchase history to a long short-term memory network, and causes it to learn a dependency relationship of a long-term purchase cycle. The present system inputs text data of social media to a pre-trained transformer model, and executes sentiment analysis and topic extraction according to a context. The present system combines intermediate feature vectors output from these respective models, and inputs them to a multilayer perceptron composed of fully connected layers. This multilayer perceptron outputs a final customer attribute label and a probability score. For example, the present system receives a tensor of a baby product purchase history for the past half year and an embedding vector of a childcare-related remark on social media as inputs. The present system outputs structured data of a life stage family demographic probability of 0.98 and a next diaper purchase predicted date of 10 days later as an output. The present system passes these prediction results to a rule-based inference engine, and links them with an identifier of a specific sales promotion campaign. The present system inputs a time-series array of location information to a convolutional neural network, and extracts a feature map of a stay pattern. Thereby, there is a technical effect of extracting a complex customer insight that cannot be discovered by a single data source with high accuracy, and improving the quality of personalization. As a specific application field, it is applicable to an advanced customer relationship management system or a life event prediction system.

The generative AI automatically generates an optimal sales promotion content and in-store experience for each customer based on these analysis results, and distributes them in real time through a plurality of channels such as an in-store signage, an electronic shelf label, an application notification, a push notification, a staff terminal, receipt printing, and e-mail distribution. For example, a 10% off coupon for a refrigerator and an experience event guidance for a new life support set for a customer staying in a home appliance corner, a fitting experience event and a limited coupon for a customer staying in a fashion corner, a tasting campaign and a recipe video for a customer staying in a food corner, and a customer service instruction according to a customer attribute for a staff terminal are automatically generated. Further, performance indicators such as a coupon usage rate, the number of signage browsings, a push notification open rate, a product purchase rate, a stay time change, a purchase rate after staff customer service, an SNS post increase rate, a receipt unit price, a repeat store visit rate, an event participation rate, and a questionnaire answer rate after sales promotion distribution are automatically aggregated in real time, and the generative AI analyzes these performance data, and automatically and continuously optimizes a selection logic of the sales promotion content, the distribution timing, the distribution channel, and the customer service instruction. Specifically, the present system synthesizes the extracted customer insight and a real-time context of the store as a prompt for a generative artificial intelligence model. This generative artificial intelligence model is a large language model having billions of parameters, and generates a natural and persuasive sales promotion text based on the input prompt. The present system renders a dynamic content in a hypertext markup language format by combining the generated text and image data acquired from a product database. The present system transmits the rendered content as a push notification to an application on a smartphone of the customer. The present system simultaneously transmits a display switching command and content data to a control terminal of a digital signage closest to a current position of the customer. The present system collects line-of-sight detection data of the customer and a tap event of the application on a stream processing platform immediately after the distribution. The present system inputs the collected reaction data to a Bayesian estimation model using a Markov chain Monte Carlo method. This model sequentially updates a posterior probability distribution of a true conversion rate of each sales promotion measure. The present system dynamically selects a next optimal sales promotion measure from the posterior probability distribution using a Thompson sampling algorithm. Thereby, there is a technical effect of completely automating a series of cycles from content generation to effect measurement and next measure optimization, and maximizing a return on investment of marketing. As a specific application field, it is applicable to an autonomous retail media network or a dynamic in-store advertisement distribution system.

Specific examples of a prompt sentence to be read by the generative AI include “propose a product category of highest interest and an optimal sales promotion content to a customer currently visiting the store based on a store visit history, a purchase history, an application usage history, and an SNS post content of this customer”, “generate a recommended product and a promotion sentence to be displayed on an in-store signage from a stay area and a past purchasing tendency of a customer”, “automatically generate a comparison table and a discount coupon for a refrigerator for a customer staying in a home appliance corner for a long time, and distribute them to an application and a signage”, and “select a most effective sales promotion pattern based on A/B test results of a plurality of sales promotion patterns, and reflect it in a next distribution”. Specifically, the present system holds these prompt templates in a database, and generates a complete query character string by binding a variable at the time of execution. The present system encodes a behavior history of the customer as a time-series event sequence, and embeds it in a context part of the prompt. The present system transmits the generated query character string as a hypertext transfer protocol request to an application programming interface of the generative artificial intelligence model. This model applies a self-attention mechanism to the input token sequence, and calculates a dependency relationship of a context. This model calculates a probability distribution of a word to be output next using a softmax function. This model searches for a word sequence having the highest likelihood using a beam search algorithm, and outputs it as a response text. For example, the present system receives a vectorized context of a customer attribute senior, a stay area health food, and a past purchase supplement as an input. This model outputs text data of a recommended product joint support supplement and a promotion sentence “healthy walking forever” as an output. The present system parses the output text data using a regular expression, and maps it to a predetermined field of a display system. The present system adds a text vector of a past success case as an example of few-shot learning in generation of the prompt. Thereby, there is a technical effect of instantly generating a personalized message having infinite variations without intervention of a human copywriter. As a specific application field, it is applicable to an automatic advertisement creative generation system or an interactive commerce bot.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

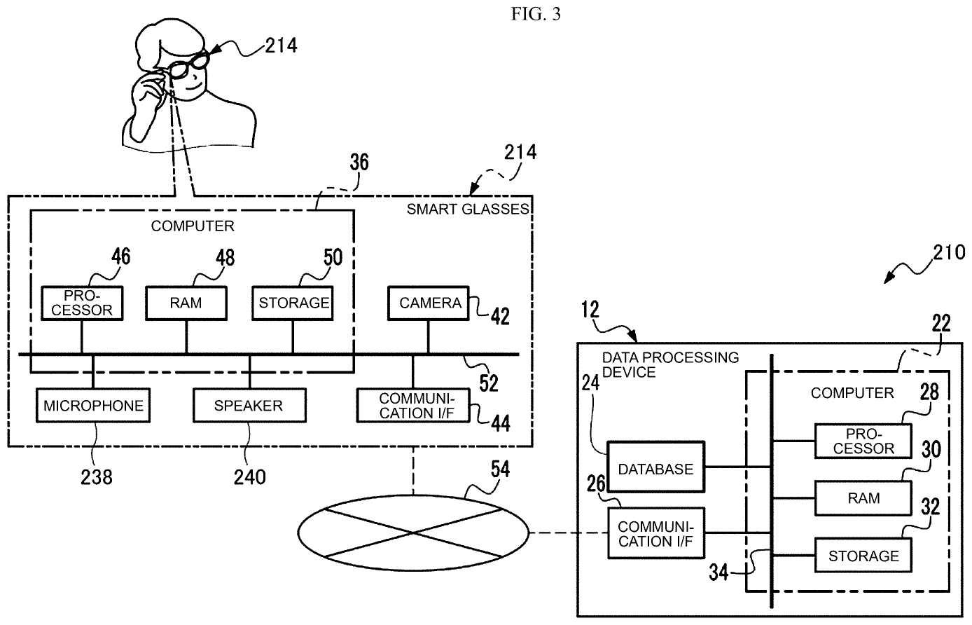

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

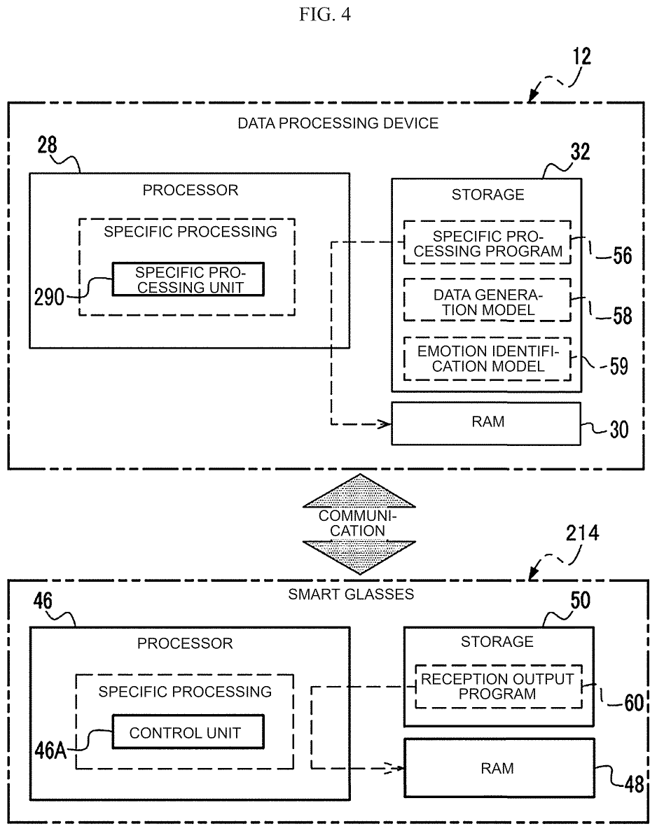

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

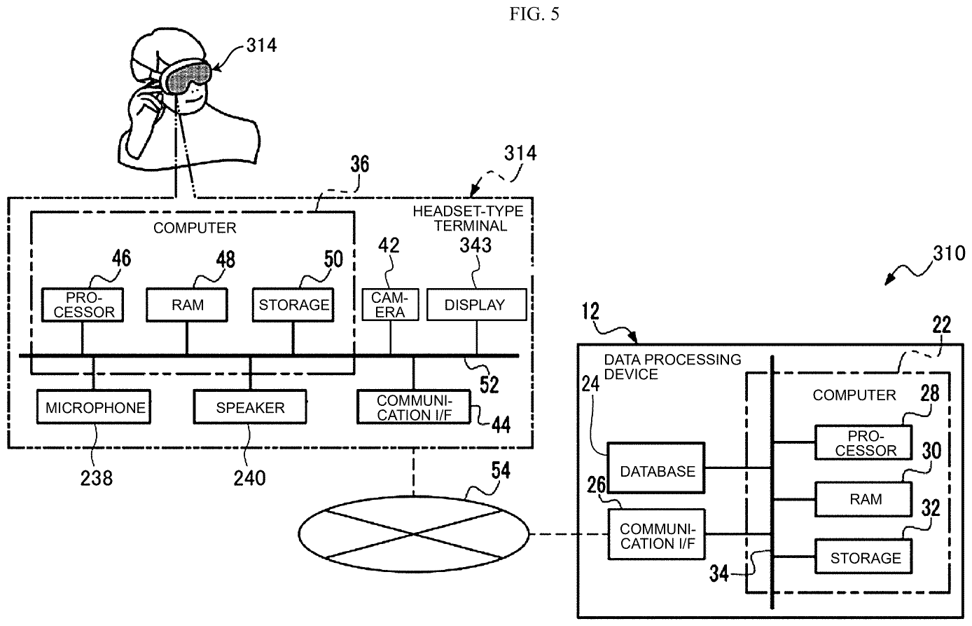

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

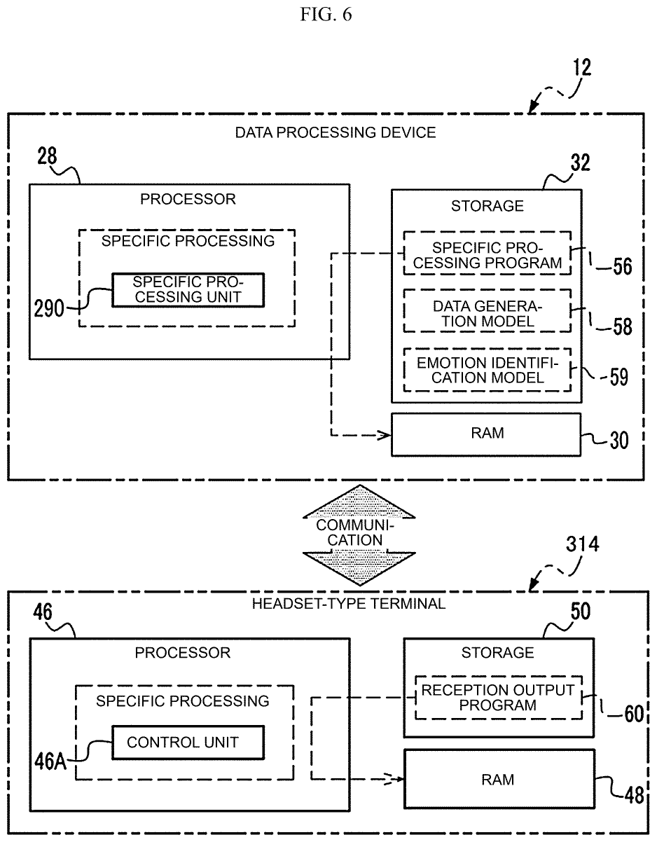

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

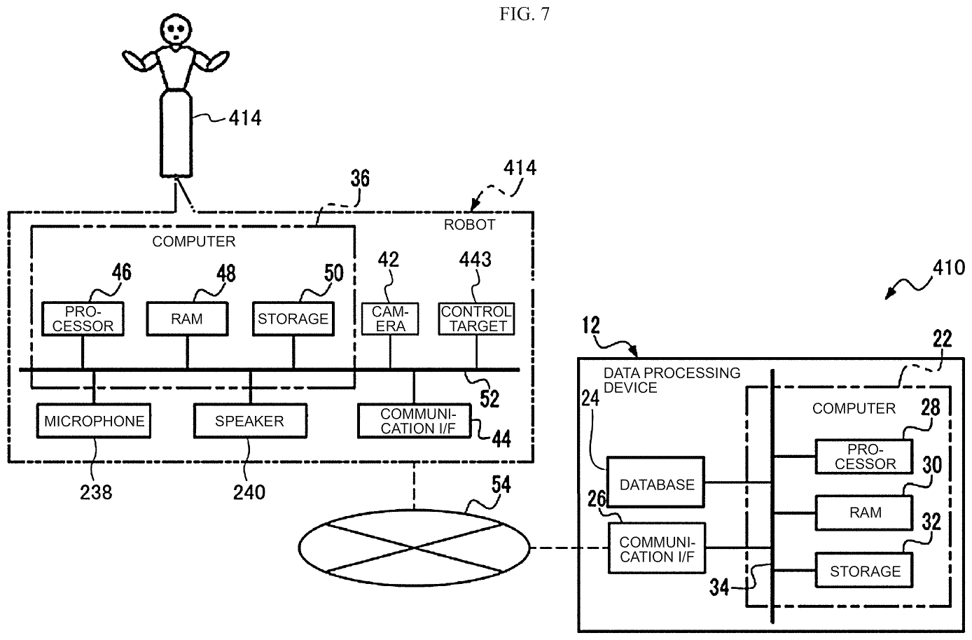

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

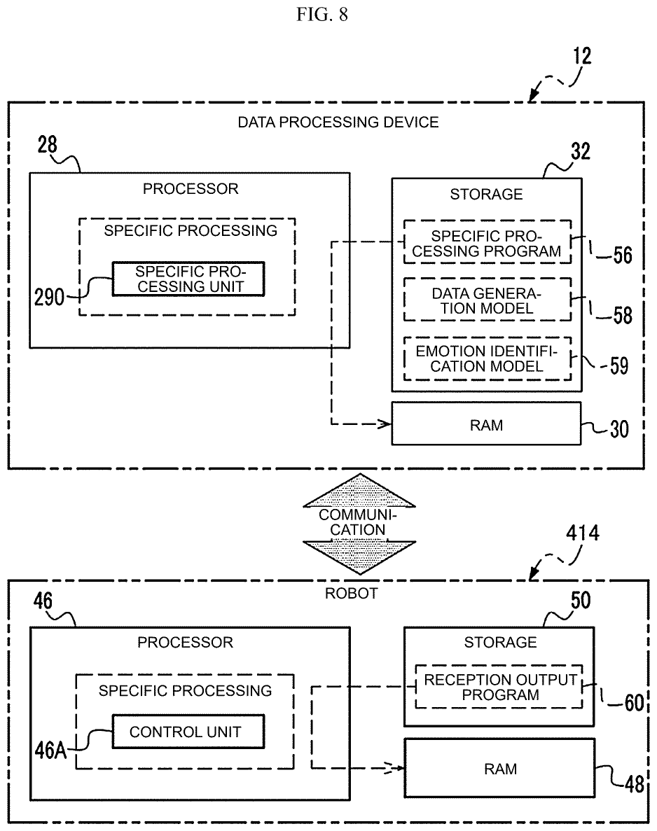

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

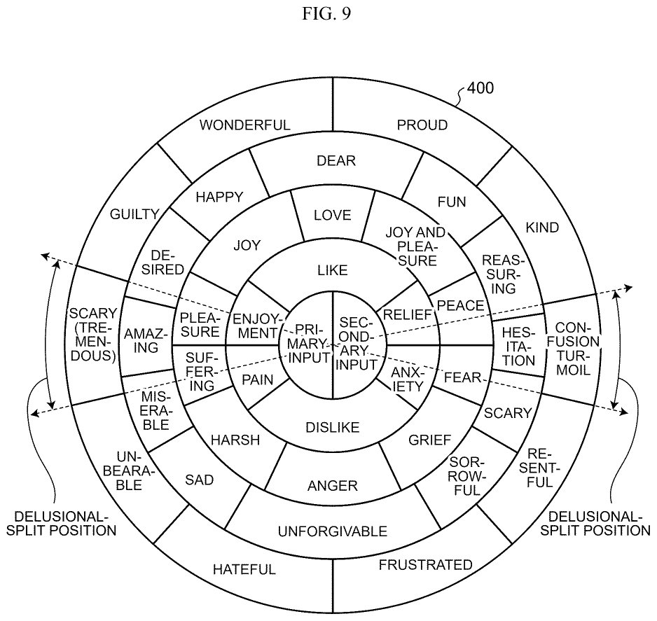

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

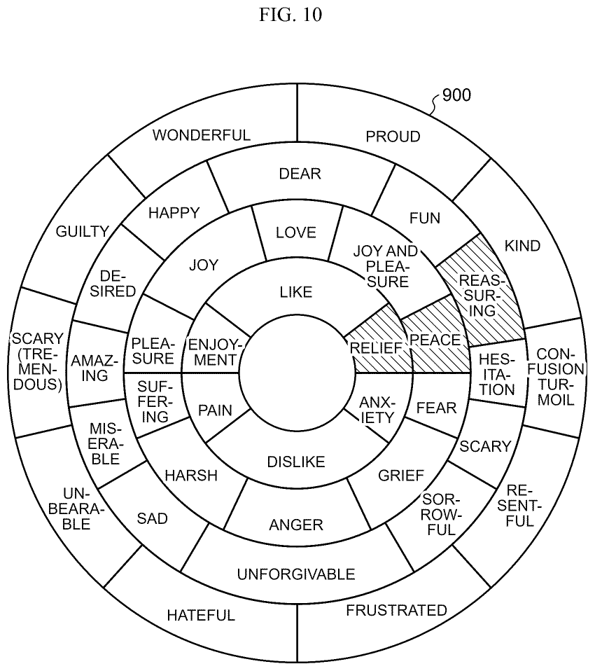

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.
(Supplementary Note 1) [0182] A personalized sales promotion system for a physical store, which is a customer experience optimization system in a physical store, comprising: a data collection unit configured to collect behavior data, purchase history data, application usage data, and SNS data of a visiting customer; a data integration unit configured to identify a plurality of types of data collected by the data collection unit using a customer ID, a member number, a terminal identifier, location information, and the like, and execute a cleansing process such as deduplication, noise removal, missing value complementation, and unification of a data format to generate an integrated customer data set; and a sales promotion generation and distribution unit configured to analyze the integrated customer data set using a generative AI, extract interests, purchasing tendencies, store visit patterns, sales floor stay tendencies, application usage tendencies, SNS transmission contents, brand preferences, and the like for each customer, further automatically generate an optimal sales promotion content, a coupon, a signage display, an application notification, a staff customer service instruction, and the like for each customer using the generative AI based on the analysis result, and distribute them in real time through a plurality of channels such as an in-store signage, a customer terminal, and a staff terminal, wherein the respective units operate in cooperation using the generative AI.
(Supplementary Note 2) [0183] The system according to Supplementary Note 1, wherein the data collection unit automatically collects various data such as customer store visit detection, an in-store movement route, a sales floor stay time, a purchase history, an in-app behavior, an SNS post content, a follow relationship, and a like history in real time or periodically using a beacon, a camera, a sensor, a POS system, a member application, an SNS linkage function, and the like, and the data integration unit executes identification processing, unification of a data format, deduplication, noise removal, and missing value complementation using a customer ID, a member number, an e-mail address, a terminal identifier, an application ID, location information, and the like by the generative AI.
(Supplementary Note 3) [0184] The system according to Supplementary Note 1, wherein the sales promotion generation and distribution unit analyzes interests, purchasing tendencies, store visit patterns, sales floor stay tendencies, application usage tendencies, SNS transmission contents, and the like for each customer using the generative AI, automatically generates a home appliance discount coupon and a new product comparison table for a customer staying in a home appliance corner, a fitting event and a limited coupon for a customer staying in a clothing corner, a tasting campaign and a recipe video for a customer staying in a food corner, and further a customer service instruction according to a customer attribute for a staff terminal, distributes real-time and personalized sales promotion information through a plurality of channels such as an in-store signage, an application notification, an electronic shelf label, and a staff terminal, analyzes a distribution result and a customer reaction thereof using the generative AI, and continuously optimizes a sales promotion content and a distribution timing.

What is claimed is:

1. A system comprising:
circuitry configured to:
receive, via a communication interface coupled to a packet-switched network, event data streams from IoT sensor devices distributed across a physical environment and terminal devices, and collect the event data streams from a plurality of data source systems via the communication interface;
apply a data integration pipeline comprising data cleansing, normalization, deduplication, and attribute complementation to the collected event data streams to generate an integrated dataset, and apply a feature extraction model to the integrated dataset to generate attribute feature vectors for each entity identifier;
apply a generative neural network model to the attribute feature vectors to generate a preference profile record for each entity identifier comprising interest indicators, behavioral pattern vectors, active time window parameters, and transmission channel identifiers;
generate an output data record for each entity identifier by applying the generative neural network model to the preference profile record and a candidate data record pool retrieved from a data record database via the communication interface, and determine an optimal packet transmission timing parameter and transmission channel identifier from the active time window parameters; and
transmit the output data record as a data packet via the transmission channel identifier at the optimal packet transmission timing parameter via the communication interface.

2. The system according to claim 1, wherein the circuitry is configured to receive time-series spatial data from IoT sensor nodes arranged in a physical environment via an edge gateway, apply noise filtering and data compression at the edge gateway, and transmit compressed feature vectors to a cloud computing node via the communication interface for integration with event data from terminal devices.

3. The system according to claim 2, wherein the circuitry is configured to apply a convolutional neural network to image tensor data from imaging devices at the edge gateway to extract person detection feature vectors, compute movement trajectory data, and transmit the movement trajectory data to the cloud computing node as part of the event data stream.

4. The system according to claim 1, wherein the circuitry is configured to apply a natural language processing model to text data in the collected event data streams to extract sentiment polarity scores and topic category labels, and incorporate the extracted sentiment polarity scores and topic category labels as additional feature dimensions in the attribute feature vector generation pipeline.

5. The system according to claim 1, wherein the circuitry is configured to apply a transformer-based time-series model to event count arrays aggregated over time windows to identify peak activity periods for each entity identifier, compute an active time window distribution, and store the active time window distribution as the active time window parameters in the preference profile record.

6. The system according to claim 5, wherein the circuitry is configured to apply a channel affinity scoring model to historical engagement rate metrics for each transmission channel identifier associated with an entity identifier, compute a channel affinity score for each transmission channel, and rank transmission channel identifiers by channel affinity score to determine the preferred transmission channel identifiers.

7. The system according to claim 1, wherein the circuitry is configured to retrieve candidate data records from the data record database by computing cosine similarity scores between a query embedding vector derived from the preference profile record and data record embedding vectors indexed in a vector database, and select candidates having similarity scores exceeding a retrieval threshold.

8. The system according to claim 7, wherein the circuitry is configured to apply a performance prediction model to each retrieved candidate data record by computing a predicted engagement score from the preference profile record and the candidate data record embedding vector, rank candidates in descending order of predicted engagement score, and select the highest-ranked candidate as the basis for the output data record.

9. The system according to claim 1, wherein the circuitry is configured to apply the generative neural network model to the selected candidate data record and the preference profile record to generate output text and select media asset identifiers appropriate to the preference profile, and format the output data record for the transmission channel identifier.

10. The system according to claim 1, wherein the circuitry is configured to receive performance feedback data records from transmission channel endpoints via the communication interface comprising engagement event records and conversion event records, compute an engagement rate metric and a conversion rate metric for each transmitted output data record, and store the performance feedback data as a performance record associated with the corresponding entity identifier.

11. The system according to claim 10, wherein the circuitry is configured to update the preference profile record by applying the generative neural network model to the performance record and the current preference profile record to extract updated preference signals, and adjust the interest indicators and behavioral pattern vectors based on the extracted preference signals.

12. The system according to claim 1, wherein the circuitry is configured to apply an A/B testing framework by generating two variant output data records for a randomly selected subset of entity identifiers, routing each variant to equal-size subsets, collecting performance feedback data for each variant, and applying a statistical significance test to determine the higher-performing variant.

13. The system according to claim 1, wherein the circuitry is configured to apply a content safety evaluation model to each generated output data record to compute a policy compliance score, and suppress transmission of output data records having policy compliance scores below a compliance threshold parameter.

14. The system according to claim 1, wherein the circuitry is configured to enforce a data privacy policy by applying consent status records associated with each entity identifier to determine which data source categories are permitted for attribute feature vector generation, and excluding data from non-consented source categories from the integrated dataset.

15. The system according to claim 1, wherein the circuitry is configured to generate a campaign performance report from aggregated performance records across all entity identifiers, apply the generative neural network model to generate a natural language summary of key engagement trends, and transmit the report to terminal devices associated with management user identifiers.

16. The system according to claim 1, wherein the circuitry is configured to update the generative neural network model by generating training pairs from historical preference profile records and corresponding validated engagement outcome records, and fine-tune the model to improve predicted engagement score accuracy.

17. The system according to claim 1, wherein the event data streams comprise sensor-derived activity records and user interaction records from terminal devices in a physical environment, the attribute feature vectors capture behavioral patterns and preference signals for each entity identifier, and the output data record is formatted for transmission as a data packet via a specified transmission channel at an optimized transmission time.

18. A system comprising:
circuitry configured to:
receive, via a communication interface coupled to a packet-switched network, event data streams from IoT sensor devices and terminal devices, and apply a data integration pipeline with cleansing, normalization, and deduplication;
apply a feature extraction model and a transformer-based time-series model to generate preference profile records comprising interest indicators, behavioral pattern vectors, and active time window parameters;
retrieve candidate data records by cosine similarity scoring from a vector database, apply a performance prediction model to rank candidates, and generate output data records using a generative neural network model;
determine optimal packet transmission timing and transmission channel identifiers from preference profile records, and transmit output data records as data packets via the communication interface; and
collect performance feedback to update preference profiles and fine-tune the generative neural network model.

19. The system according to claim 18, wherein the circuitry is configured to apply an A/B testing framework by generating variant output data records for randomly selected entity identifier subsets, apply a statistical significance test to determine higher-performing variants, and apply a content safety evaluation model to compute policy compliance scores before transmission.

20. A method comprising:
receiving, via a communication interface coupled to a packet-switched network, event data streams from IoT sensor devices and terminal devices, and applying a data integration pipeline to generate an integrated dataset;
applying a feature extraction model to generate attribute feature vectors, and a generative neural network model to generate preference profile records comprising interest indicators, behavioral pattern vectors, and active time window parameters;
generating output data records by applying the generative neural network model to preference profile records and candidate data records retrieved by cosine similarity search; and
transmitting the output data records as data packets via transmission channel identifiers at optimal packet transmission timing parameters determined from the preference profile records.
